(19) United States
(12) Patent Application Publication
(10) Pub. No.: US 2024/0278137 A1
(43) Pub. Date: Aug. 22, 2024

(54) Driving Simulation System and Methods for Managing Driving Simulation Centers

(71) Applicant: The Track at Asheville, LLC, Asheville, NC (US)

(72) Inventor: Joel Lee-Jay Bergstein, Asheville, NC (US)

(73) Assignee: The Track at Asheville, LLC, Asheville, NC (US)

(21) Appl. No.: 18/442,810

(22) Filed: Feb. 15, 2024

Related U.S. Application Data
(60) Provisional application No. 63/446,986, filed on Feb. 20, 2023.

(51) Int. Cl. A63F 13/803; A63F 13/86; G09B 9/05

(52) U.S. Cl. CPC A63F 13/803; A63F 13/86; G09B 9/05; A63F 2300/8017

(57) ABSTRACT

A driving simulation system. The driving simulation system may include one or more driving simulator pods. The one or more driving simulator pods may include a simulated driver cockpit, including simulated vehicle controls; one or more displays providing a simulated driving environment to a driver of the one or more driving simulator pods, and a driving simulator pod computer. The driving simulation system may further include a session server; an outcome engine; an operations user interface; a plurality of data stores; one or more processors; and a non-transitory computer-readable medium storing thereon instructions that, when executed by the one or more processors, may cause the system to, receive by the outcome engine an outcome request associated with at least one of the one or more driving simulator pods; process the outcome request to determine if the outcome request is valid or not valid; and implement the outcome request if valid.

### RELATED APPLICATIONS

This application is related and claims priority to U.S. Provisional Patent Application No. 63/446,986, filed on Feb. 20, 2023 the application of which is incorporate herein by reference in its entirety.

### TECHNICAL FIELD

The subject matter of the invention relates generally to “sim racing” and more particularly to a driving simulation system and methods for managing driving simulation centers.

### BACKGROUND

Simulated racing or “sim racing” is one of the eSports. Generally, eSports is an online gaming venue that mimics the experience of watching and/or participating in a professional sporting event. For example, the experience of sim racing places the driver inside a setup that gives the overall look, feel, and sensation of driving on a real racetrack. Sim racing uses technology to make motorsports accessible and allows aspiring drivers the adventure of real-world racecar driving, without leaving their seat.

In sim racing, the driving apparatus is called a “driving simulator” or “sim rig” or “sim pod.” The “sim pod” is provided as a single seat for one driver. However, because owning your own sim pod can be cost prohibitive, driving simulation centers exist that have multiple sim pods. Users can reserve driving time on a sim pod at a driving simulation center, which is an affordable alternative to ownership. Accordingly, driving simulation centers provide an environment in which multiple customers (i.e., drivers) may use sim pods individually or in groups for some type of activity.

Currently, the simulation software that runs on a sim pod is designed for a single user with a single sim pod. The current simulation software is not designed for operating and/or managing a driving simulation center including multiple sim pods. For example, for a simulation center operator, managing multiple sim pods in a driving simulation center is a very manual process that is prone to mistakes and/or other inefficiencies. Accordingly, using the current simulation software, it is difficult for simulation center operators to manage multiple sim pods with their individual and/or groups of drivers and their various activities.

### SUMMARY

In one embodiment, a driving simulation system is provided. The driving simulation system may include one or more driving simulator pods. The one or more driving simulator pods may include a simulated driver cockpit, including simulated vehicle controls; one or more displays providing a simulated driving environment to a driver of the one or more driving simulator pods, and a driving simulator pod computer. The driving simulation system may further include a session server; an outcome engine; an operations user interface; a plurality of data stores; one or more processors; and a non-transitory computer-readable medium storing thereon instructions that, when executed by the one or more processors, may cause the system to, receive by the outcome engine an outcome request associated with at least one of the one or more driving simulator pods; process the outcome request to determine if the outcome request is valid or not valid; and implement the outcome request if valid. Processing the outcome request may further include, if the outcome request is determined to be valid, determining whether the outcome request is or is not impactful to a driver associated with the driving simulator pod associated with the outcome request, and if determined to be impactful, requiring confirmation of the outcome request prior to implementing the outcome request. Implementing an outcome request determined to be valid and impactful may include the outcome engine generating a state graph of all states that the driving simulator pod associated with the outcome request can be in, wherein the outcome engine queries a state data store of one of the plurality of data stores for all state information of the driving simulator pod associated with the outcome request. The system may further include the outcome engine generating a plan for implementing the outcome request based on the state graph and state information, wherein the outcome engine analyzes all available paths of the state graph and generates the plan taking the least amount of time and/or steps. The system may further include executing the generated plan, which may include completing a first step of the generated plan; and determining if the outcome request is achieved. The system may further include recording a state change of the driving simulator pod associated with the outcome request after completing the first step of the generated plan in the state data store. If it is determined that the outcome request is not achieved, then the system may further include the outcome engine (a) generating a new state graph of the driving simulator pod associated with the outcome request; (b) generating a new plan based on the new state graph and state information; (c) completing a first step of the generated new plan; (d) determining if the outcome request is achieved; and wherein if it is determined the outcome request is not achieved repeating (a)-(d), until the outcome request is achieved. The system may further include recording a state change of the driving simulator pod associated with the outcome request after completing the first step of each new generated plan in the state data store. The outcome request may be input via the operations user interface. The system may further include a spectator module and a spectator display, wherein the spectator module may be programmed to drive the spectator display to allow a broadcast of a simulated event or race of one or more driving simulator pods of the driving simulation system, wherein the spectator display may be remote of the one or more driving simulator pods. The system may further include a driver web portal including a web based portal wherein a driver of one or more of the driving simulator pods of the driving simulation system may access the driving simulation system and interact with a simulation center, their account, and/or their driver data. The plurality of data stores may include one or more of a driver data store, a state data store, a static data store, and/or a simulation center data store. Validating the outcome request may include, determining if a state change of the outcome request is impactful to the driver of the one or more driving simulator pods associated with the outcome request; if it is determined that the state change of the outcome request is impactful to the driver, generating a state graph by the outcome engine; based on the state graph, determining by the outcome engine if there is a valid plan to implement the state change of the outcome request; and if it is determined there is a valid plan, marking the outcome request as validated and return the plan for confirmation and implementation. The system may further include, if it is determined by the outcome engine that there is not a valid plan, then marking the outcome request as not validated and returning a reason for the failed validation for confirmation. The system may further include, if it is determined that the state change of the outcome request is not impactful to the driver then marking the outcome request as validated and return plan for confirmation and implementation. A first outcome request can be linked to a second outcome request by a trigger event, wherein upon the occurrence of the trigger event the second outcome request is implemented.

In another embodiment, a method of managing a driving simulation center is provided. The method may include accessing a driving simulation system. The driving simulation system may include one or more driving simulator pods, the one or more driving simulator pods may include: a simulated driver cockpit, including simulated vehicle controls; one or more displays providing a simulated driving environment to a driver of the one or more driving simulator pods, and a driving simulator pod computer. The system may further include a session server; an outcome engine; an operations user interface; a plurality of data stores; and one or more processors. The method may further include, receiving by the outcome engine an outcome request associated with at least one of the one or more driving simulator pods; processing the outcome request to determine if the outcome request is valid or not valid; and implementing the outcome request if valid.

### BRIEF DESCRIPTION OF THE DRAWINGS

Having thus described the subject matter of the invention in general terms, reference will now be made to the accompanying drawings, which are not necessarily drawn to scale, and wherein:

FIG. 1 illustrates a block diagram of an example of a driving simulation system for managing driving simulation centers configured in accordance with an embodiment of the invention;

FIG. 2 illustrates a block diagram of an example of the driving simulation system for managing driving simulation centers configured in accordance with an embodiment of the invention;

FIG. 3 illustrates a block diagram of an example of the driving simulation system for managing driving simulation centers configured in accordance with an embodiment of the invention;

FIG. 4A and FIG. 4B illustrate block diagrams of an example of a driving simulator of the driving simulation system for managing driving simulation centers, in accordance with an embodiment of the invention;

FIG. 5 illustrates a perspective view of an example of a driving simulator of the driving simulation system for managing driving simulation centers, in accordance with an embodiment of the invention;

FIG. 6 illustrates a block diagram of an example of a spectator module of the driving simulation system for managing driving simulation centers, in accordance with an embodiment of the invention;

FIG. 7 illustrates a block diagram of an example of a session server of the driving simulation system for managing driving simulation centers, in accordance with an embodiment of the invention;

FIG. 8 illustrates a simplified schematic view of an example of a simulation center of the driving simulation system for managing driving simulation centers, in accordance with an embodiment of the invention;

FIG. 9 illustrates a block diagram of an example of a data processing-portion of the driving simulation system for managing driving simulation centers, in accordance with an embodiment of the invention;

FIG. 10 illustrates a simplified block diagram of an example of the operations user interface-portion of the driving simulation system for managing driving simulation centers, in accordance with an embodiment of the invention;

FIG. 11 illustrates a flow diagram of an example of a method of processing an outcome request in the driving simulation system according to a simplest configuration, in accordance with an embodiment of the invention;

FIG. 12 illustrates a flow diagram of another example of a method of processing an outcome request of the driving simulation system, in accordance with an embodiment of the invention;

FIG. 13 illustrates a flow diagram of an example of a method of implementing a requested end state or outcome of the driving simulation system, in accordance with an embodiment of the invention;

FIG. 14 illustrates a flow diagram of an example of a method of validating an outcome request of the driving simulation system, in accordance with an embodiment of the invention;

FIG. 15 through FIG. 27 illustrate schematic views of an example of an operations user interface of the driving simulation system, in accordance with an embodiment of the invention; and

FIG. 28 illustrates a flow diagram of an example of a state graph of the driving simulation system, in accordance with an embodiment of the invention.

### DETAILED DESCRIPTION

The subject matter of the invention now will be described more fully hereinafter with reference to the accompanying drawings, in which some, but not all embodiments of the subject matter of the invention are shown. Like numbers refer to like elements throughout. The subject matter of the invention may be embodied in many different forms and should not be construed as limited to the embodiments set forth herein; rather, these embodiments are provided so that this disclosure will satisfy applicable legal requirements. Indeed, many modifications and other embodiments of the subject matter of the invention set forth herein will come to mind to one skilled in the art to which the subject matter of the invention pertains having the benefit of the teachings presented in the foregoing descriptions and the associated drawings. Therefore, it is to be understood that the subject matter of the invention is not to be limited to the specific embodiments disclosed and that modifications and other embodiments are intended to be included within the scope of the appended claims.

In some embodiments, the subject matter of the invention provides a driving simulation system and methods for managing driving simulation centers including driving simulators, driver details, and broadcasts of races.

In some embodiments, the driving simulation system and methods provide a driving simulation center that may include one or more driving simulators, a session server including one or more dedicated servers, an outcome engine, an operations user interface (UI), a driver web portal, and multiple data stores, such as, but not limited to, a driver data store, a state data store, a static data store, a center data store, and the like.

In some embodiments, the driving simulation system and methods provide ways of managing driving simulation centers, driving simulators (aka “sim rigs” and “sim pods”), driver data, and/or broadcasts of races.

In some embodiments, the driving simulation system and methods provide data processing capability for delivering driver data to drivers after racing in an easily consumable and interesting way.

In some embodiments, the driving simulation system and methods provide a driving simulation center that may include a spectator module for supporting broadcasts of races.

In some embodiments, the driving simulation system and methods provide a method of operating the driving simulation system that may include, for example, the steps of processing an outcome request, validating an outcome request, and then implementing a requested end state or outcome.

In some embodiments, the driving simulation system and methods provide an outcome engine and an operations user interface (UI) that may be used to automate and/or simplify the operations and/or management of driving simulation centers by simulation center operators.

In some embodiments, the driving simulation system and methods provide an outcome engine that uses, for example, mathematical state graphs to automate the operations of driving simulation centers by optimizing the paths from one outcome state to other outcome states of driving simulators and/or races.

In some embodiments, the driving simulation system and methods provide a system configuration wherein substantially all components thereof may be provided entirely local to the driving simulation center.

In some embodiments, the driving simulation system and methods provide a system configuration wherein certain components thereof may be provided local to the driving simulation center and wherein other components thereof may be cloud-based.

In some embodiments, the driving simulation system and methods provide a platform including a suite of technologies to enable the intelligent operation of a driving simulation center.

In some embodiments, the driving simulation system and methods provide a platform that may be used to leverage a high level of automation and thereby reduce greatly the knowledge, experience, and attention that is currently required to operate a plurality of driving simulators in a way that is flexible to each driver.

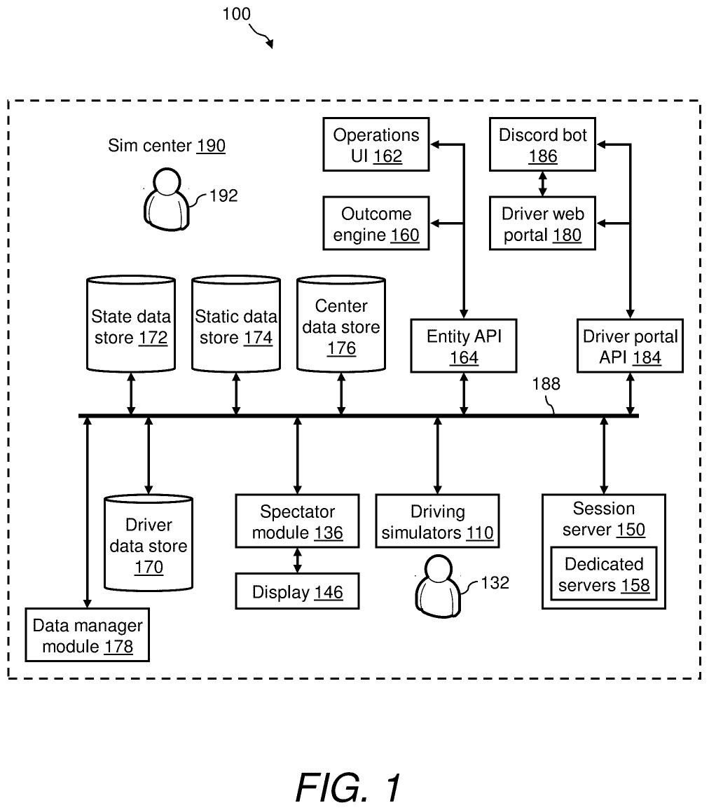

Referring now to FIG. 1 is a block diagram of an example of a driving simulation system 100 for managing driving simulation centers configured in accordance with an embodiment of the invention. In this example, substantially all components of driving simulation system 100 may be provided entirely local to a driving simulation center 190, hereafter called sim center 190. Further, a sim center operator 192 may be associated with sim center 190. That is, sim center operator 192 may be the individual responsible for operating and/or managing sim center 190.

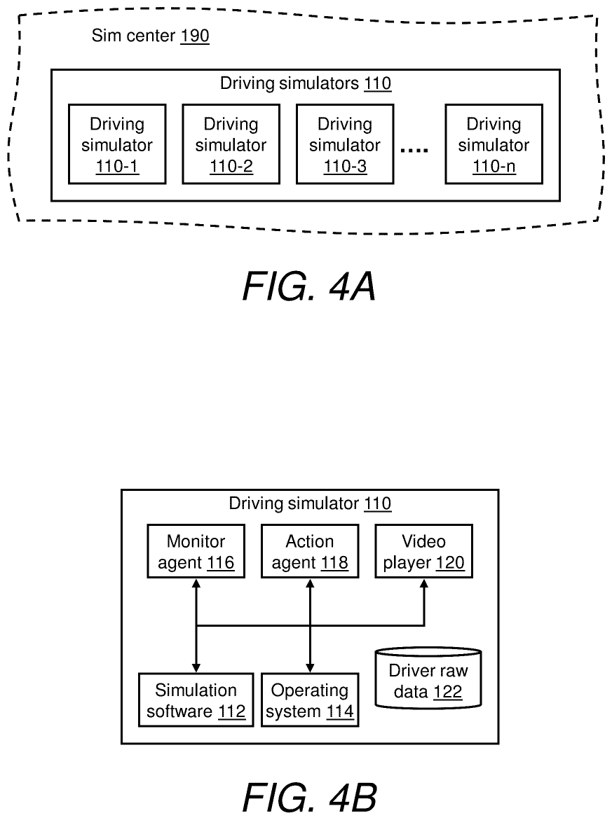

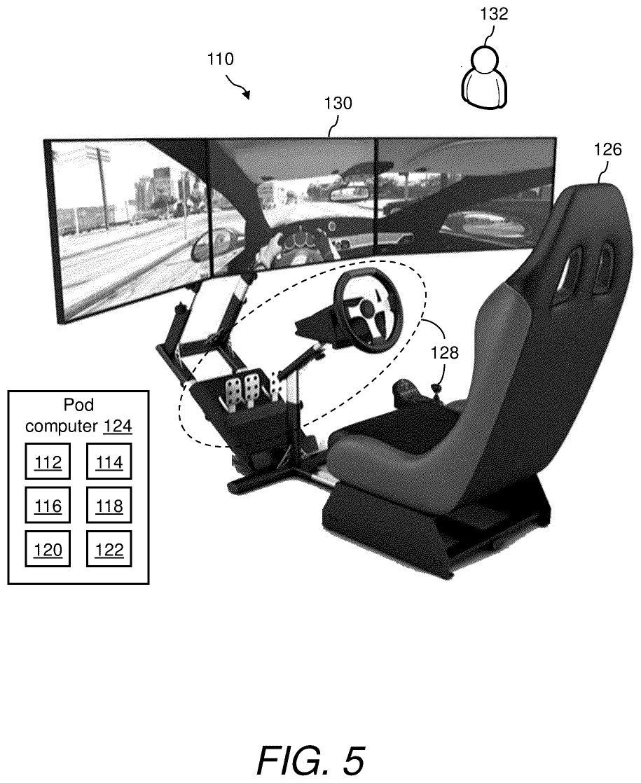

Driving simulation system 100 may include one or more driving simulators 110. Each of the driving simulators 110 may be a driving apparatus designed to mimic a real-world racecar for real-world racecar driving. Driving simulators 110 are also known as “sim rigs” and “sim pods.” A driver 132 may be associated with each of the driving simulators 110. More details of driving simulators 110 are now described with reference to FIG. 4A, FIG. 4B, and FIG. 5. For example, FIG. 4A and FIG. 4B are block diagrams of an example of a driving simulators 110, while FIG. 5 is a perspective view of an example of an apparatus forming a driving simulator 110.

FIG. 4A shows that driving simulation system 100 may include any number of driving simulators 110, such as driving simulator 110-1, driving simulator 110-2, driving simulator 110-3, through driving simulator 110-n. FIG. 4B shows that each of the driving simulators 110 may include, for example, certain simulation software 112, an operating system (OS) 114, a monitor agent 116, an action agent 118, a video player 120, and driver raw data 122. Additionally, FIG. 5 shows simulation software 112, OS 114, monitor agent 116, action agent 118, video player 120, and driver raw data 122 all running on a pod computer 124.

FIG. 5 also shows that the apparatus forming each of the driving simulators 110 may include a driver seat 126, certain driving controls 128 that are used by a driver 132, and a simulator display 130. Driving simulator 110 is designed to mimic a real-world racecar. Therefore, driver seat 126 and driving controls 128 may mimic those found in real racecars. Driving controls 128 may include, for example, a steering wheel, an accelerator pedal, a brake pedal, a clutch pedal, and/or a shifter (i.e., shifting lever). Further, simulator display 130 may be designed to mimic the windshield of a real-world racecar. In one example, to mimic the width and/or contour of a windshield, simulator display 130 may be formed of multiple, e.g., three, digital displays arranged side-by-side and at certain viewing angles, as shown in FIG. 5. Further, video player 120 may be used to drive simulator display 130, which may be the three digital displays.

In one non-limiting example, simulation software 112 may be the rFactor 2 software available from Image Space Incorporated (ISI) (Ann Arbor, MI). OS 114 may be any standard computer operating system for managing the operations of driving simulator 110.

Further, monitor agent 116 may be a pod monitoring agent that runs locally on each driving simulator 110. For example, monitor agent 116 may be used to monitor the simulator state, the driving telemetry, the pod computer state, and the like. Then after collecting the data, the monitor agent 116 may place the states into state data store 172.

Further, action agent 118 may be a pod action agent that runs locally on each driving simulator 110. For example, action agent 118 may be used to send commands to simulation software 112, send keystrokes to simulation software 112, start and end simulation software 112, control what is displayed on simulator display 130 of driving simulator 110, and the like. Action agent 118 may interact with OS 114.

Further, driver raw data 122 may be any data collected during a driving session and then associated and stored with respect to the specific driver 132 that is using the driving simulator 110. Accordingly, driver raw data 122 may be driver-specific data. The driver-specific data stored in driver raw data 122 may include any race session data, such as, but not limited to, driver name, timestamp, sim center information, activity or event information, sim pod information, track information, car information, race information, lap data, and the like. Car information may include, for example, starting fuel level, tire compound, wheel camber, and so on. Further, the driver-specific data stored in driver raw data 122 may include telemetry data. This data may include any metrics of car, such as, but not limited to, forces present on car and/or engine, car drafting, car not drafting, xyz coordinates, velocity, acceleration, brake position, throttle position, transmission position, and the like.

Referring now again to FIG. 1, driving simulation system 100 may provide a full stack software platform that automates much of the operation of a simulation center (e.g., sim center 190). Further, driving simulation system 100 may provide valuable information to drivers 132 and sim center operator 192, enabling a medium for the simulation center to engage with its customers.

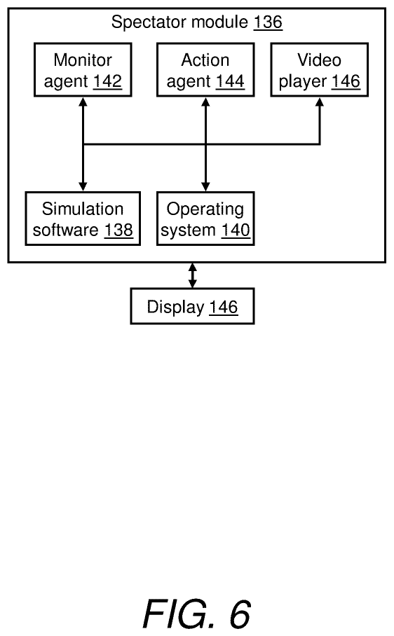

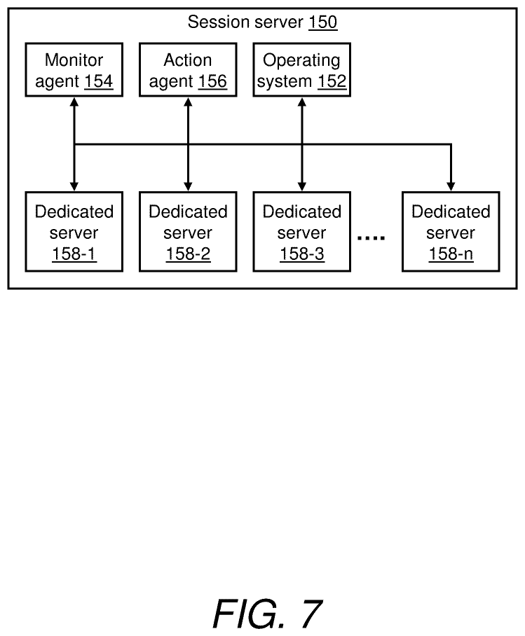

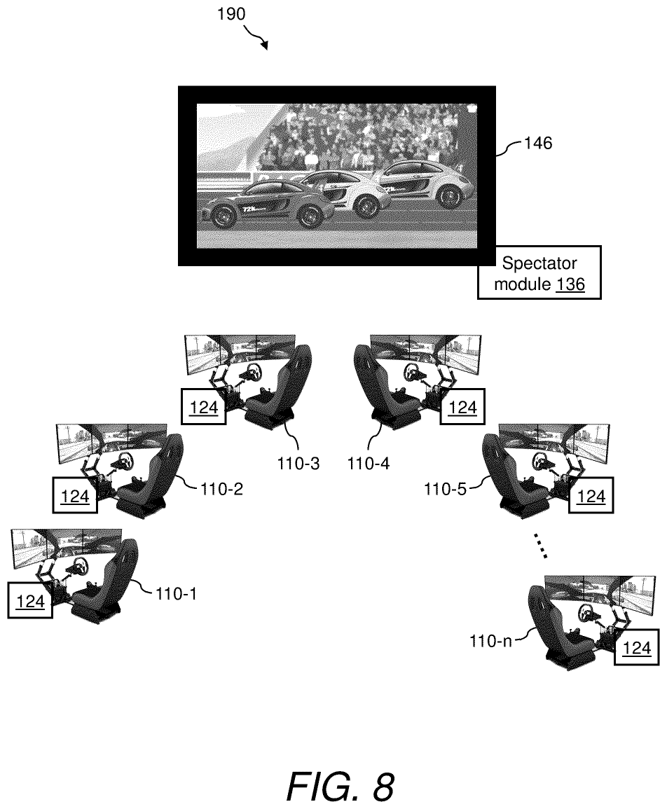

Referring still to FIG. 1, driving simulation system 100 may further include a spectator module 136 that drives a display 146 and a session server 150 that may further include multiple dedicated servers 158. More details of an example of spectator module 136 are shown and described below in FIG. 6. More details of an example of session server 150 are shown and described below in FIG. 7. Further, more details of an example of sim center 190 including multiple driving simulators 110 and spectator module 136 are shown and described below in FIG. 8.

Further, driving simulation system 100 may include an outcome engine 160, an operations user interface (UI) 162, and an entity application programming interface (API) 164.

Outcome engine 160 may be the logic engine of driving simulation system 100 for (1) validating proposed outcomes, (2) determining the next action to reach the desired outcome, and (3) sending the action. Using entity API 164, outcome engine 160 may be used to interrogate state data store 172 for the current state of any components (or entities) of driving simulation system 100. Then, outcome engine 160 may use that data as context for its decisions. Outcome engine 160 may be used to control the “main” or “overall” states of any components (or entities) of driving simulation system 100 (e.g., driving simulators 110). However, outcome engine 160 may also be used to control other settings or “minor” states of any components (or entities) of driving simulation system 100. For example, certain settings or “minor” states of a driving simulator 110 may be changed only when the driving simulator 110 is in a certain “main” or “overall” state. Further to the example, the color of a car (i.e., a minor state) cannot be changed when the car is in onTrack (i.e., the overall state).

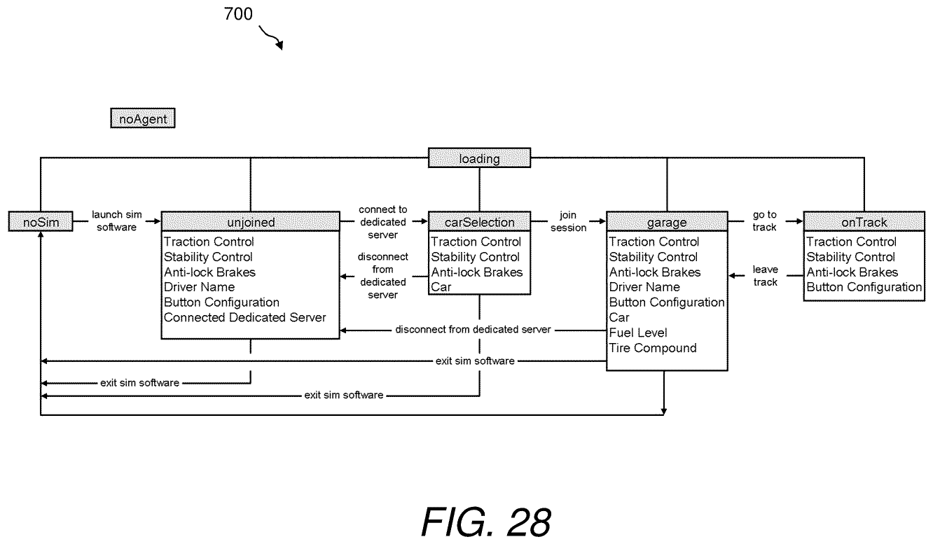

In driving simulation system 100 and using outcome engine 160, want to get from point A to point B, while at the same time making sure to encounter every point that is needed to make the changes to the settings that are needed. For example, the driving simulator 110 may be onTrack. Then, want to change to a different car and still be onTrack. Same beginning and end state. But in order to make the change to the settings, some other states have to occur. Car has to go back to the garage state. Then change the car. Then return to onTrack, but with the different car. In this example, in addition to any “overall” states, outcome engine 160 determines any other settings or “minor” states that need to be changed. More details of this scenario are shown and described below with respect to a state graph shown in FIG. 28.

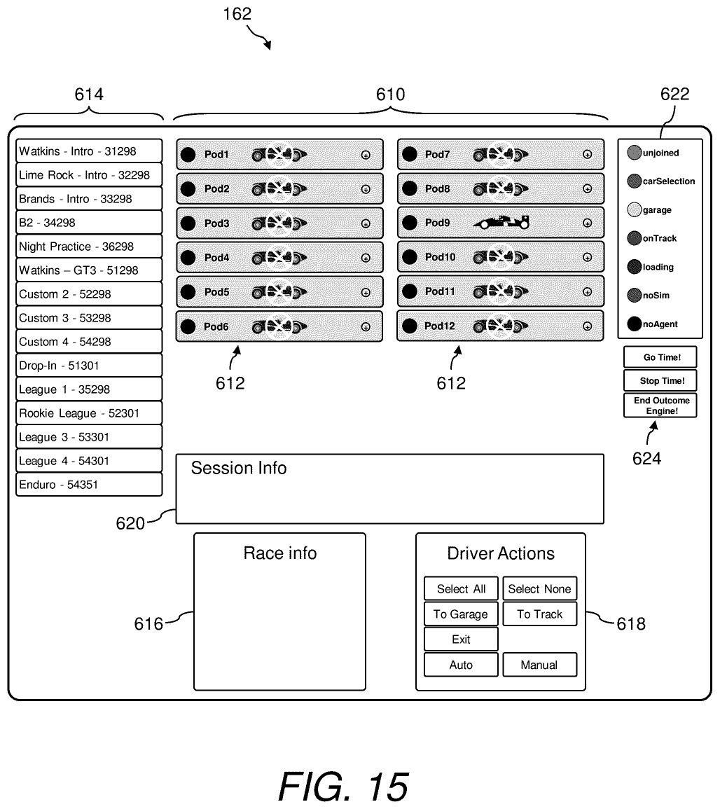

Operations UI 162 of driving simulation system 100 may be, for example, a web-based application that may be used by sim center operators 192 to operate a driving simulator 110 and/or a sim center 190. In one example, operations UI 162 may be used to run a session with a few driving simulators 110 at one particular sim centers 190. In another example, operations UI 162 may be used to run a session that includes driving simulators 110 from multiple sim centers 190. In yet another example, operations UI 162 may be used by a driver 132 in a self-service scenario for a single driving simulator 110. More details of an example of operations UI 162 are shown and described below in FIG. 15 through FIG. 27.

Further, operations UI 162 of driving simulation system 100 may be a declarative interface to a graph-based state mapping feature of outcome engine 160. The graph-based state mapping feature of outcome engine 160 may be used to achieve the outcome specified by the sim center operator 192 or other system component. Further, outcomes can be “chained” into a fully automated event where they are linked by triggers. For instance, the first outcome may be that the driving simulator 110 is on track in a specific car/track in a practice session. The second outcome may be that the driving simulator 110 is on track in that same car/track in a race, and the trigger is that 15 minutes of practice has elapsed.

Generally, entity API 164 may serve as the communications hub of driving simulation system 100. Entity API 164 may be an http API for interacting with both, but not limited to, outcome engine 160 and operations UI 162 of driving simulation system 100. That is, entity API 164 allows outcome engine 160 and/or operations UI 162 to exchange data with any component (or entity) of driving simulation system 100. In one example, entity API 164 may be a cloud-based API.

More specifically, entity API 164 receives and fulfills data requests from any valid sources. Valid sources may include, for example, driver web portal 180, operations UI 162, outcome engine 160, and any action agents (e.g., action agents 118, 144, 156). When the source is operations UI 162, entity API 164 receives and forwards outcome requests to outcome engine 160. When the source is outcome engine 160, entity API 164 receives and forwards actions to the appropriate action agent.

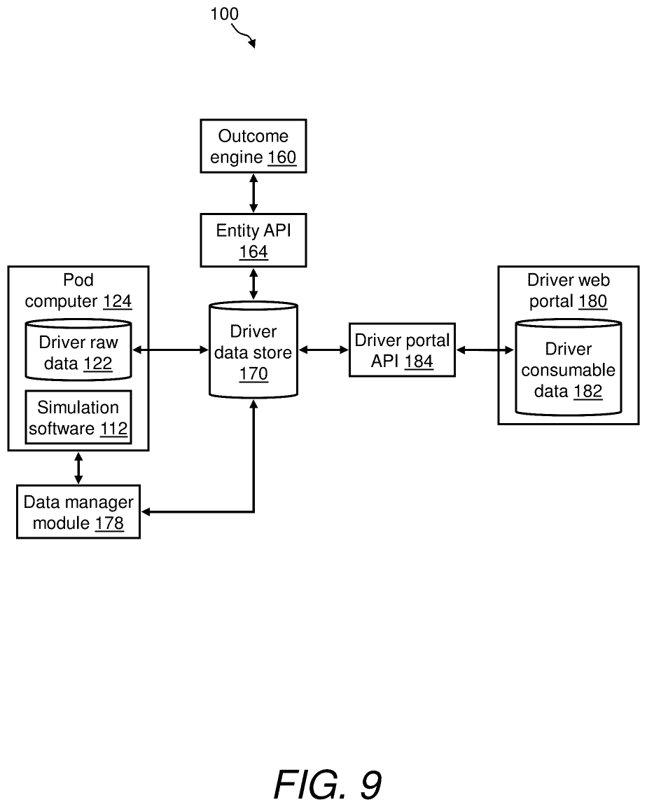

Further, driving simulation system 100 may include multiple data stores, such as, but not limited to, a driver data store 170, a state data store 172, a static data store 174, and a center data store 176. Further, a data manager module 178 may be used to manage any data flow and data storage within driving simulation system 100. Further, data manager module 178, along with outcome engine 160, may be used to perform data analysis within driving simulation system 100. More details of an example of data processing within driving simulation system 100 is shown in FIG. 9 and described below.

Driver data store 170 may be a database, such as, but not limited to, a relational database. Any information about drivers 132 may be stored in driver data store 170. For example, driver information may include demographic information for each driver 132, such as driver name, address, account information, payment information, login credentials, and the like. Driver information stored in driver data store 170 may also include any driver-specific race session data, such as, but not limited to, sim center information, activity or event information, sim pod information, track information, car information, race information, lap data, and telemetry data, and all timestamped.

Other data stored in driver data store 170 may include the results of the telemetry data analysis. For example, this may include the results of data aggregation (i.e., what track does a driver 132 drive the most, correlation (i.e., the driver 132 always have a top 5 lap time in formulas cars), and trending (i.e., the driver 132 lap times this month are 5% faster on average than last month). Further, certain “achievement” goals may be established and stored in driver data store 170. For example, store those achievements that have been achieved as well as progress towards those achievements that have not yet been achieved.

State data store 172 may be, for example, a NoSQL database for the storage and retrieval of simulator state data. There may be one instance of state data store 172 per sim center 190. Further, state data store 172 may be running local to the sim center 190 or may be cloud-based.

Generally, the state of anything that can be changed is stored in state data store 172. In order to support a declarative outcome engine 160, the current state of anything that can be changed needs to be known. Anything that may be controlled via the outcome engine 160 has a current state, plus all settings are stored in state data store 172. In one example, the states of all driving simulators 110 may be stored in state data store 172. Examples of driving simulator 110 states may include, but are not limited to, the following.
“unjoined”—means the simulation software 112 at the driving simulator 110 is running, but not joined to a dedicated server 158;
“carSelection”—means the simulation software 112 at the driving simulator 110 is running and joined, but waiting on car selection to proceed to track loading;
“garage”—means the simulation software 112 at the driving simulator 110 is running and the car is loaded into the garage;
“onTrack”—means the simulation software 112 at the driving simulator 110 is running and the car is on track;
“loading”—means the simulation software 112 at the driving simulator 110 is running, but nothing can be done;
“nosim”—means the simulation software 112 at the driving simulator 110 is not running but the monitor agent 116 is checking in; and
“noAgent”—means the monitor agent 116 at the driving simulator 110 is not checking in.

Each of the abovementioned states may be considered an “overall” state. However, “minor” states may also exist. Examples of minor states may include—car is currently loaded, the track, the driver name, the traction control level, and so on. In a specific example, the driving simulator 110 may be in the overall state of “onTrack.” At the same time, the traction control may be in a state of low, high, medium, or off; all minor states. In another example, the states of all dedicated servers 158 may be stored in state data store 172. Examples of dedicated server 158 states may include, but are not limited to, the following.
“noAgent”—means the monitor agent 154 at the session server 150 is not checking in.
“NoDedi”—means the dedicated server 158 is not running or not responding to the monitor requests;
“loading”—means the dedicated server 158 is running, but nothing can be done;
“Running”—means the dedicated server 158 is running and accepting client connections;

Again, each of the abovementioned states may be considered an “overall” state. However, “minor” states may also exist.

In yet other examples, the states of some other components that may be stored in state data store 172 may include spectator module 136, a timer display on the wall of the sim center 190, a camera system to show the drivers' in stream, a reactive lighting system to communicate to local spectators, and the like. Static data store 174 may be a database, such as, but not limited to, a relational database. For example, information stored in static data store 174 may include static data about, for example, sim-specific mappings to generalized friendly names, state definitions, setting definitions, per car settings, per car cameras, per track cameras, default configurations, session types, and the like.

Center data store 176 may be a database, such as, but not limited to, a relational database. For example, information stored in center data store 176 may include any information about driving simulators 110, sim center 190, drivers 132, events, leagues, telemetry, and the like.

Further, driving simulation system 100 may include a driver web portal 180, a driver portal API 184, and a discord bot 186 and wherein “bot” is short for robot. Driver web portal 180 provides, for example, a website by which drivers 132 may interact with their account and data. For example, driver web portal 180 may provide access to membership account information, driver achievement information, lap data, telemetry data, comparison data to other drivers, league and/or other competition results or information. Further, driver web portal 180 may be used for booking sessions at a sim center 190.

Discord bot 186 may be, for example, an instant messaging digital platform designed for creating communities. For example, discord bot 186 may allow user/driver interaction. Further, discord bot 186 may be used to analyze data and send notifications of interesting information to drivers 132. An example of a notification that may be sent to a driver 132 may be “You're about to set a new record on the Watkins Glen track. Do you want to book a session?”.

Driving simulation system 100 for managing driving simulation centers is not limited to the configuration shown in FIG. 1. For example, while FIG. 1 shows substantially all components of driving simulation system 100 provided entirely local to sim center 190, other configurations are possible that may include cloud-based components (i.e., non-local or networked components).

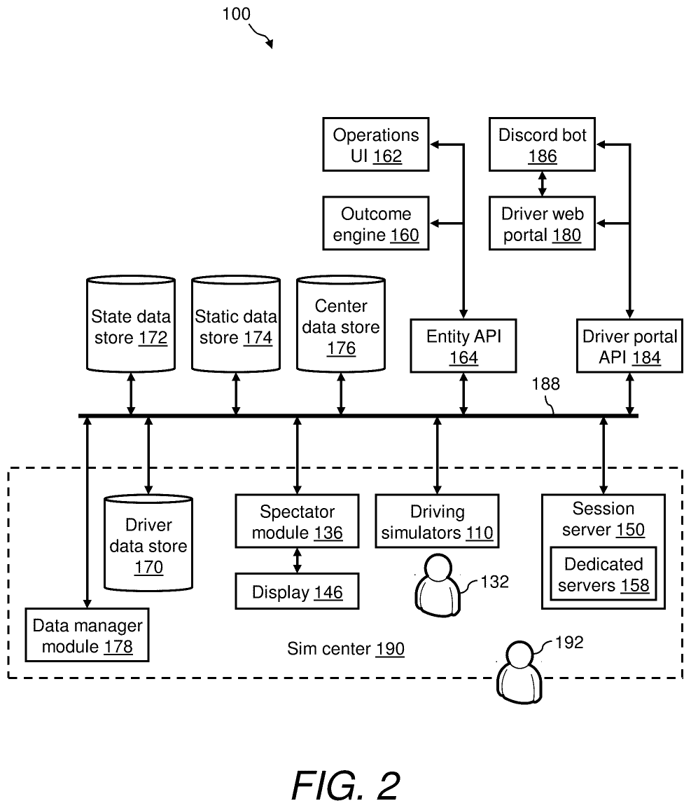

In one example, FIG. 2 shows a block diagram of driving simulation system 100 according to another configuration. In this configuration, the multiple driving simulators 110, spectator module 136 with display 146, session server 150, driver data store 170, and data manager module 178 may be provided local to sim center 190. By contrast, outcome engine 160, operations UI 162, entity API 164, state data store 172, static data store 174, center data store 176, driver web portal 180, driver portal API 184, and discord bot 186 may be networked or cloud-based components.

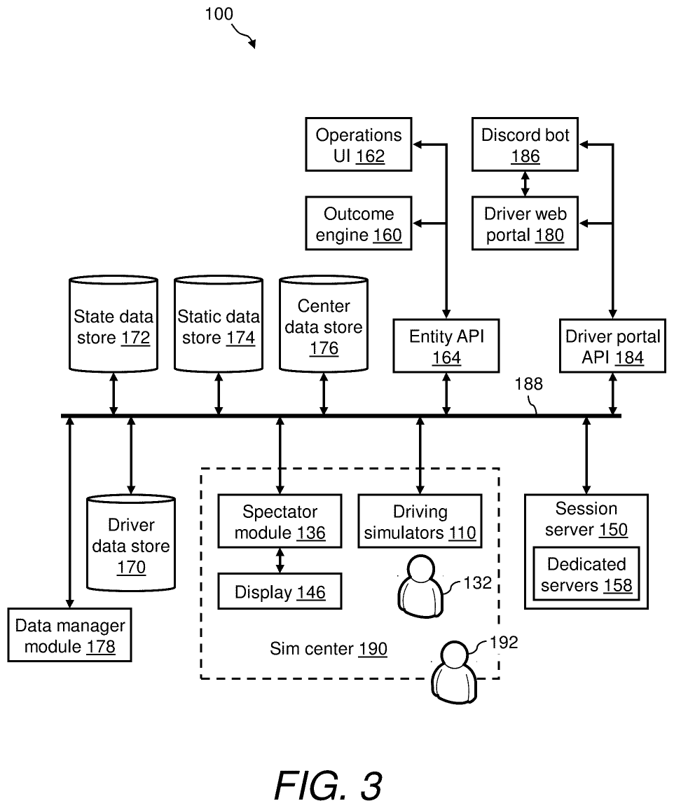

In another example, FIG. 3 shows a block diagram of driving simulation system 100 according to yet another configuration. In this configuration, only the multiple driving simulators 110 and spectator module 136 with display 146 may be provided local to sim center 190. By contrast, session server 150, outcome engine 160, operations UI 162, entity API 164, driver data store 170, state data store 172, static data store 174, center data store 176, data manager module 178, driver web portal 180, driver portal API 184, and discord bot 186 may be networked or cloud-based components.

Referring now to FIG. 1, FIG. 2, and FIG. 3, in one example there may be one instance of outcome engine 160 at each sim center 190. In another example there may be one cloud-based instance of outcome engine 160 that manages multiple sim centers 190.

Referring still to FIG. 1, FIG. 2, and FIG. 3, driving simulation system 100 may include a communications bus 188 for exchanging information between any hardware, software, and/or networked components thereof. Communications bus 188 may be any combinations of wired and/or wireless communication interfaces by which information may be exchanged. Examples of wired communication interfaces may include, but are not limited to, USB ports, RS232 connectors, RJ45 connectors, Ethernet, and any combinations thereof. Examples of wireless communication interfaces may include, but are not limited to, an Intranet connection, Internet, ISM, Bluetooth® technology, Bluetooth® Low Energy (BLE) technology, Wi-Fi, Wi-Max, IEEE 402.11 technology, ZigBee technology, Z-Wave technology, 6LoWPAN technology (i.e., IPv6 over Low Power Wireless Area Network (6LoWPAN)), ANT or ANT+ (Advanced Network Tools) technology, radio frequency (RF), Infrared Data Association (IrDA) compatible protocols, Local Area Networks (LAN), Wide Area Networks (WAN), Shared Wireless Access Protocol (SWAP), any combinations thereof, and other types of wireless networking protocols known now or in the future.

Referring now to FIG. 6 is a block diagram of an example of spectator module 136 of driving simulation system 100 for managing driving simulation centers. In this example, spectator module 136 may include certain simulation software 138, an OS 140, a monitor agent 142, an action agent 144, and a video player 146.

In one example, simulation software 138 may be the rFactor 2 software available from Image Space Incorporated (ISI) (Ann Arbor, MI). OS 140 may be any standard computer operating system for managing the operations of spectator module 136.

Further, monitor agent 142 may be a monitoring agent that runs locally on spectator module 136. For example, monitor agent 142 may be used to monitor the states of spectator module 136 and/or video player 146. Then after collecting the data, the monitor agent 142 places the states into state data store 172.

Further, action agent 144 may be an action agent that runs locally on spectator module 136. For example, action agent 144 may be used to send commands to simulation software 138, send keystrokes to simulation software 138, start and end simulation software 138, control what is displayed on display 146 of spectator module 136, and the like. Action agent 144 may interact with OS 140. In one example, display 146 may be any commercially available high-definition large screen TV.

Referring now to FIG. 7 is a block diagram of an example of session server 150 of driving simulation system 100 for managing driving simulation centers. In this example, session server 150 may include an OS 152, a monitor agent 154, and an action agent 156. Further, any number of dedicated servers 158 may be running on session server 150. For example, dedicated server 158-1, dedicated server 158-2, dedicated server 158-3, through dedicated server 158-n.

That is, multiple instances of a dedicated server 158 may be launched and running on session server 150. In one example, three instances of dedicated server 158 may be indicated by dedicated server 158-1, dedicated server 158-2, and dedicated server 158-3. In another example, ten instances of dedicated server 158 may be indicated by dedicated server 158-1 through dedicated server 158-10.

Monitor agent 154 may be a monitoring agent that runs locally on session server 150. For example, monitor agent 154 may be used to monitor the states of session server 150 and each of the dedicated servers 158. Then after collecting the data, the monitor agent 154 places the states into state data store 172. Further, action agent 156 may be an action agent that runs locally on session server 150. For example, action agent 156 may be used to send commands to any of the dedicated servers 158, send keystrokes to any of the dedicated servers 158, start and end any dedicated server 158, and the like. Action agent 156 may interact with OS 152.

Referring now to FIG. 8 is a simplified schematic view of an example of sim center 190 (a simulation center) of driving simulation system 100 for managing driving simulation centers. In this example, FIG. 8 shows multiple driving simulators 110, each with its own pod computer 124. Further, sim center 190 may include spectator module 136 with its display 146. The presence of spectator module 136 allows spectators to watch any event or race taking place within sim center 190, as if watching the event or race on TV at home.

Referring now to FIG. 9 is a block diagram of an example of a data processing-portion of driving simulation system 100 for managing driving simulation centers. For simplicity, the data processing is shown with respect to one driving simulator 110. Accordingly, FIG. 9 shows an arrangement of one pod computer 124 including simulation software 112, outcome engine 160, entity API 164, driver raw data 122 may include driver web portal 180 and driver portal API 184, driver data store 170, data manager module 178, and driver web portal 180. Driver web portal 180 may further include driver consumable data 182. Generally, driver consumable data 182 may be any driver data or information after it has been processed and made useful or user friendly.

In one example, driving simulation system 100 has data processing capability to (1) intelligently group data into “sessions,” (2) process data for interesting metrics, (3) manage membership benefits, (4) record driver achievements, and (5) potentially normalize data from different sources (e.g., different simulation software, real data loggers, etc.).

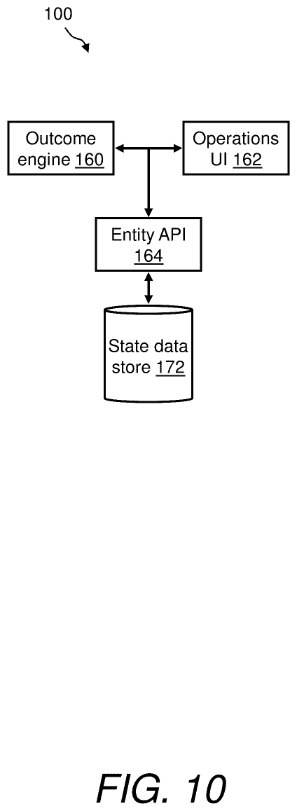

Referring now to FIG. 10 is a simplified block diagram of an example of the operations UI-portion (e.g., operations UI 162) of driving simulation system 100 for managing driving simulation centers. For example, FIG. 10 shows an arrangement of outcome engine 160, operations UI 162, entity API 164, and state data store 172.

In one example, operations UI 162 uses entity API 164 to request the current state and then displays this information to the sim center operator 192. For example, entity API 164 pulls the requested data from state data store 172 and passes the information to the operations UI 162 for display. Then, operations UI 162 indicates desired outcome for one or more entities (e.g., driving simulators 110, dedicated servers 158, spectator module 136, etc.). Then, operations UI 162 submits the outcome request(s) to entity API 164. The, entity API 164 forwards the outcome request(s) to outcome engine 160 for implementation.

Referring still to FIG. 10, operations UI 162 may be used to provide multiple views, for example, a view for sim center operator 192 (e.g., see FIG. 15 through FIG. 27) and a view for the self-service driver 132.

With respect to sim center operators 192, operations UI 162 may be used to provide an intuitive and intelligent interface for certain tasks, such as, but not limited to, the following.
Manage driving simulator 110 setup:
   assigned driver,
   what dedicated server 158 to connect to,
   car,
   assists,
   other in-sim settings,
Manage spectator (e.g., spectator module 136):
   what dedicated server 158 to connect to,
   automatic camera settings,
   manual camera operations,
   overlay settings,
Manage dedicated servers 158:
   start/end session,
   change conditions (weather/penalties/etc.),
Observe status:
   driving simulator 110 and dedicated server 158 states,
   current in sim status,
      telemetry,
      lap times, etc.
Identify issues:
   driving simulator 110 and/or dedicated server 158 stuck in state,
   hardware warnings, etc.
Uses custom heuristics to make suggestions to sim center operator 192, such as:
   driver needs assistance,
   driver is running out of time,
   driver may want to practice for their upcoming league event, etc.

Referring now again to FIG. 1 through FIG. 10, the simulation technology of driving simulation system 100 may be summarized as follows. The simulation consists of three entities—
(1) the simulation software 112 running on each driving simulator 110. That is, each driving simulator 110 hosts an instance of the simulation software, which is simulation software 112;
(2) the session server 150, which is an application that defines the parameters of the session and connects the driving simulators 110. That is, session server 150 that runs the dedicated server 158 may run many instances of the dedicated server 158. Each instance of the dedicated server 158 provides a single car/track combo (potentially more than one car). All driving simulators 110 that join to a specific dedicated server 158 are on track together. A “private” session can be created simply by launching an additional instance of the dedicated server 158; and
(3) the spectator module 136, which is an instance of the simulation that joins only to “watch” the race rather than to drive. That is, spectator module 136 may be used for streaming the race from a TV spectator view. For example, the cameras can be controlled and time can be reversed for replays. The data being overlayed can be controlled, i.e., lap times, position in race, etc.

Referring still to FIG. 1 through FIG. 10, driving simulation system 100 may provide a platform including a suite of technologies to enable the intelligent operation of a driving simulation center (e.g., sim center 190). Leveraging a high level of automation, the platform reduces greatly the knowledge, experience, and attention that is currently required to operate a plurality of driving simulators in a way that is flexible to each driver.

Currently available solutions provide little automation, requiring sim center operators to track the state of all things and click a button for every action. By contrast, driving simulation system 100 may be used to leverage a multi-directional graph of simulator states as well as detailed information on what settings can be changed in what state, and the implications of those changes. This state graph may be used with a custom traversal algorithm to create a declarative interface to setting the state of entities in a sim center 190. The custom traversal algorithm being, for example, outcome engine 160. It is called this because, being declarative in approach, the sim center operator 192 indicates the desired end state, outcome, and the algorithm (e.g., outcome engine 160) determines the most efficient path that leads to that state, if possible.

By way of example, Table 1 below shows examples of state descriptions. For example, Table 1 represents possible states for the driving simulator 110. There may similarly possible states for every setting. For example, there may be a setting for traction control, and that may be set to values of 0, 1, or 2. These values may have friendly names of off, low, medium, and high. Generally, there may be hundreds of options that can potentially be controlled, but there may be about less than 50 that are likely changed regularly. Further. Table 2 below shows an example of different paths from one state to another.

TABLE 1
Examples of State Descriptions

| STATE_ID | STATE_NAME | STATE_DESCRIPTION |
|---|---|---|
| 1 | unjoined | Sim is running, but not joined to a dedicated server |
| 2 | carSelection | Sim is running and joined-waiting on car selection |
| | | to proceed to track loading |
| 3 | garage | Sim is running and loaded into the track |
| 4 | onTrack | Sim is running and car is on track |
| 5 | loading | Sim is running, but nothing can be done |
| 6 | nosim | Sim is not running but the agent is checking in |
| 7 | noAgent | Agent is not checking in |

Note:
“sim” means simulation software 112 at the driving simulator 110

TABLE 2
Example of Different Paths

| | Starting | | | DURATION |
|---|---|---|---|---|
| PATH_ID | state | Next state | ACTION | (MS) |
| 1 | unjoined | carSelection | Connect to dedicated | 5000 |
| | | | server | |
| 2 | carSelection | garage | Join session | 15000 |
| 3 | garage | onTrack | Go to track | 2000 |
| 4 | onTrack | garage | Leave track | 5000 |
| 5 | carSelection | unjoined | Disconnect from | 5000 |
| | | | dedicated server | |
| 6 | garage | unjoined | Disconnect from | 5000 |
| | | | dedicated server | |
| 7 | unjoined | nosim | Exit sim software | 10000 |
| 8 | carSelection | nosim | Exit sim software | 10000 |
| 9 | garage | nosim | Exit sim software | 10000 |
| 10 | nosim | unjoined | Launch sim software | 10000 |

Note:
“sim” means simulation software 112 at the driving simulator 110

Further, in Table 1 and Table 2 above and as used herein below, “path” means a single movement from one state to another. By contrast, “plan” means a series of paths or steps to achieve a certain outcome.

Further, in addition to Table 1 and Table 2 above, an example of a state graph is shown and described below in FIG. 28.

Referring still to FIG. 1 through FIG. 10, outcomes may be queued by specifying a trigger. For instance, if a driver books a 30-minute practice session at 2:30, an outcome can set for that car to be on the specified track, with a trigger of the time being at or beyond 2:27. Then, with another outcome to exit the sim with a trigger of the time being at or beyond 3:00. These can get much more complex as any data collected could be leveraged for a trigger. A reusable set of outcomes with triggers can be saved as a recipe. The automation and declarative construct allow for a self-healing nature which would also enable a self-service implementation.

In addition to outcome engine 160, the platform provided by driving simulation system 100 may be used to collect data from each of the entities for varied usage. Much of this may be race data, lap times, and lap telemetry used for providing driver improvement opportunities and intelligently managing “sessions.” Sessions are ways of grouping laps. This could be as simple as a practice session or as complex as a long-term qualifying session where several criteria must be met for the lap to count. The driver improvement opportunities may come from providing simple lap telemetry analysis including self-comparison and comparison to other drivers. Trending of lap times while taking conditions in to account may also be used to provide insights. In addition, the collected data may be used in gamification and marketing. The data may be used to create achievements for drivers 132 and let drivers 132 know when they are close to an achievement.

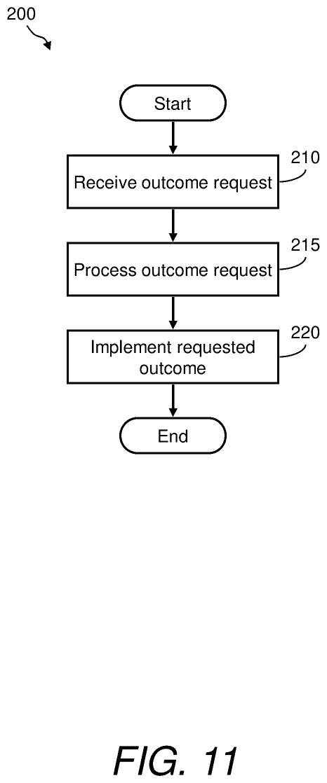

Referring now to FIG. 11 is a flow diagram of an example of a method 200 of processing an outcome request in driving simulation system 100 according to a simplest configuration, in accordance with an embodiment of the invention. Method 200 may include, but is not limited to, the following steps.

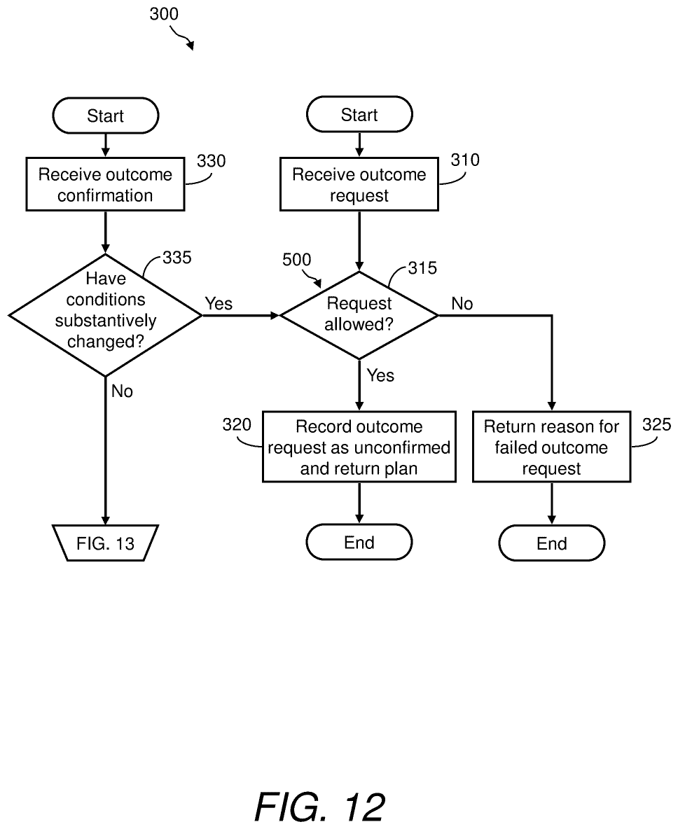

At a step 210, an outcome request is received. For example, based on input of a sim center operator 192 using operations UI 162, outcome engine 160 may receive an outcome request. More specifically, step 210 may be processed according to a method 300 shown and described below in FIG. 12.

An outcome is, essentially, a data object describing the desired state of an entity (i.e., a driving simulator 110). As an example:

```
{
  “11”: {
    “Traction Control”: “High”,
    “Transmission”: “Auto”,
    “Anti-lock Brakes”: “High”,
    “Stability Control”: “High”,
    “Control Mapping”: “Basic”,
    “connectedDedi”: “Intro-1”,
    “carLivery”: “#18”,
    “car”: “Fiat 128”,
    “state”: “garage”
  }
}
```

describes getting pod 11 to the garage in the Fiat 128 with certain assists and settings. Anything unspecified is assumed to be unchanged.

There could be a simple request to change them to manual:

```
{
  “11”: {
    “Transmission”: “Manual”
  }
}
```

At a step 215, the outcome request is processed. For example, the outcome request process may involve two components—(1) determine whether the outcome request is valid (i.e., is possible) or not valid (i.e., not possible), and (2) determine whether the outcome request is or is not impactful to the driver 132 and thus needs confirmation of the sim center operator 192. Examples of outcome requests that may have no impact on the driver 132 may include changing the assist levels, or to what control a certain button is mapped to. By contrast, an example of a driver impact is an impact to their lap time. Such a request may be held back and implemented when the driver 132 is not on the track.

When the outcome request is determined to be valid (i.e., is possible) and/or sim center operator 192 confirms the outcome request as being impactful or not impactful, then the outcome request may be implemented in step 220.

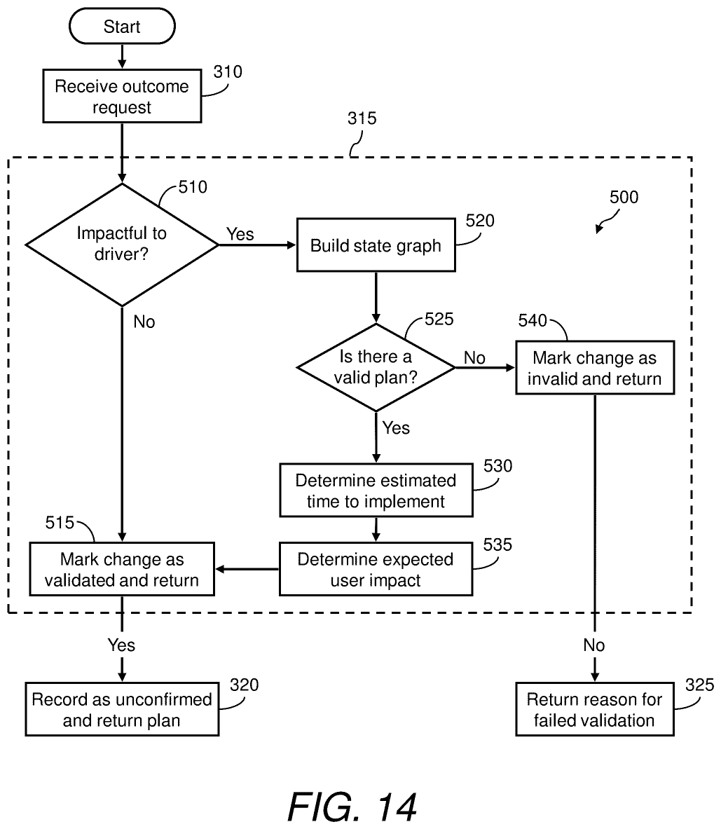

Further to the example, step 215 may be processed according to a method 500 shown and described below in a FIG. 14.

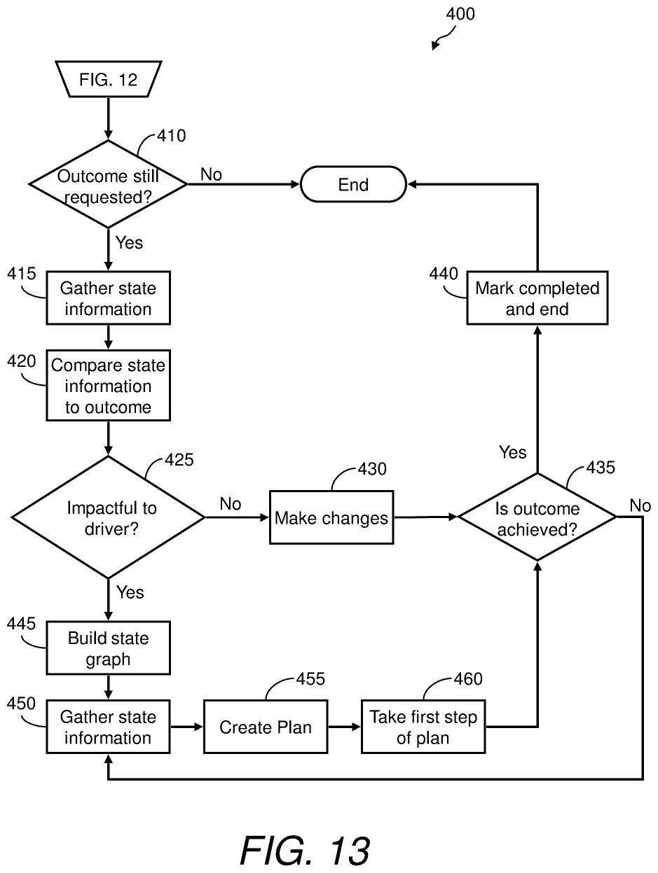

At a step 220, the requested outcome is implemented. For example, outcome engine 160 may be used to implement the requested outcome. More specifically, step 220 may be processed according to a method 400 shown and described below in a FIG. 13.

Further to the example, method 200 may be used to process impactful changes that require confirmation from the sim center operator 192. That is, certain outcome requests (or changes) would return the plan as unconfirmed (but valid), and upon confirmation by the sim center operator 192, would then be implemented, understanding that it would affect the driver 132.

Alternately, an outcome could be found to be invalid. That is, no path was found from the current state to the requested outcome. This could be because one of the specified settings doesn't exist, or the selected dedicated server 158 is not online, etc. These are all conditions that should be protected against in the UI implementation, but want to catch and report on them here, if encountered.

Further, the confirmation could also preset the operator the option to specify a trigger. Here is an example scenario:
a. A group of drivers is doing laps in a car on track;
b. One of them asks to change to a different car and they all agree;
c. The operator specifies the outcome of the new car;
d. The validation process determine that the outcome is valid but will impact the drivers by the effect of removing them from the track;
e. The UI receives this and presents a confirmation to the operator; and
f. The confirmation gives options of:
   i. cancel
   ii. go now
   iii. go when each driver finishes their current lap
   iv. go in x minutes

The operator chooses one of the options a, b, c, d, e, or f and it is implemented

Referring now to FIG. 12 is a flow diagram of an example of method 300 of processing an outcome request of driving simulation system 100, in accordance with an embodiment of the invention. Method 300 may include, but is not limited to, the following steps.

At a step 310 (i.e., one starting step of method 300), an outcome request is received. For example, based on input of a sim center operator 192 using operations UI 162, outcome engine 160 may receive an outcome request. Method 300 may proceed to step 315.

At a decision step 315, it is determined whether the outcome request is allowed according to, for example, method 500 shown in FIG. 14. For example, it may be determined whether (1) the outcome request is valid (i.e., is possible) or not valid (i.e., not possible), and/or (2) the outcome request is or is not impactful to the driver 132 and thus needs confirmation of the sim center operator 192.

When the outcome request is determined to be valid (i.e., is possible) and/or sim center operator 192 confirms the outcome request as not impactful to the driver 132, then method 300 may proceed to step 320. However, when the outcome request is determined to be not valid (i.e., not possible) and/or sim center operator 192 confirms the outcome request as impactful to the driver 132, then method 300 may proceed to step 325.

Further to the example, impactful changes may require confirmation from the sim center operator 192. That is, certain outcome requests (or changes) would return the plan as unconfirmed (but valid), and upon confirmation by the sim center operator 192, would then be implemented, understanding that it would affect the driver 132.

Alternately, an outcome could be found to be invalid. That is, no path was found from the current state to the requested outcome. This could be because one of the specified settings doesn't exist, or the selected dedicated server 158 is not online, etc. These are all conditions that should be protected against in the UI implementation, but want to catch and report on them here, if encountered.

At a step 320, the outcome request is recorded as unconfirmed and then a plan is returned. For example, the outcome request is recorded as unconfirmed in state data store 172. Then, using operations UI 162, a plan is returned from outcome engine 160 to the sim center operator 192 for confirmation. Method 300 ends.

At a step 325, a reason for the failed outcome request is returned. For example, using operations UI 162, a reason for the failed validation is returned from outcome engine 160 to the sim center operator 192 for confirmation. A reason for the failed outcome request may be that the outcome request is determined to be not valid (i.e., not possible) and/or sim center operator 192 confirms the outcome request as impactful to the driver 132. In a specific example, a failed outcome request may be a request to change a setting that does not exist, or to change a setting that is not available for a certain type of car (e.g., changing the traction control on a car that does not have traction control). Method 300 may end.

At a step 330 (i.e., another starting step of method 300), an outcome confirmation may be received. For example, using operations UI 162, the outcome confirmation may be received by outcome engine 160 from the sim center operator 192.

At a decision step 335, it is determined whether the conditions have substantively changed. For example, outcome engine 160 queries state data store 172 and determines whether the conditions have substantively changed. If the conditions have not substantively changed, then method 300 may proceed to method 400 shown in FIG. 13. However, if the conditions have substantively changed, then method 300 may proceed to step 315 for revalidation.

Referring now to FIG. 13 is a flow diagram of an example of method 400 of implementing a requested end state or outcome of driving simulation system 100, in accordance with an embodiment of the invention. Method 400 may include, but is not limited to, the following steps.

At a decision step 410, it is determined whether an outcome is still requested. For example, outcome engine 160 determines whether an outcome is still requested. If the outcome is still requested, then method 400 may proceed to step 415. However, if the outcome is no longer requested, then method 400 may end.

At a step 415, the state information is gathered. For example, outcome engine 160 queries state data store 172 for state information of, for example, a certain driving simulator 110. Method 400 may proceed to step 420.

At a step 420, the state information is compared to the requested outcome. For example, outcome engine 160 compares the state information of a certain driving simulator 110 to the requested outcome. Method 400 may proceed to step 425.

At a decision step 425, it is determined whether the requested state change is impactful to the driver. For example, outcome engine 160 determines whether the requested state change has no impact to the driver. If the change is not impactful to the driver, then method 400 may proceed to step 430. However, if the change is impactful to the driver, then method 400 may proceed to step 445.

At a step 430, changes are made to the state. For example, outcome engine 160 makes changes to the state for implementing the outcome request. Method 400 may proceed to step 435.

At a decision step 435, it is determined whether the outcome is achieved. For example, outcome engine 160 determines whether the outcome is achieved. If the outcome is achieved, then method 400 may proceed to step 440. However, if the outcome is not achieved, then method 400 may proceed to step 450.

At a step 440, the plan for implementing the outcome request is marked as completed and the method end. For example, outcome engine 160 marks the plan for implementing the outcome request as being completed. Method 400 may end.

At a step 445, a state graph is built. For example, outcome engine 160 builds a mathematical state graph of all the different states that the driving simulator 110 of interest can be in (see Table 1 and Table 2). As is well known, a mathematical state graph may be made up of multiple nodes and links. Method 400 may proceed to step 450.

At a step 450, the state information is gathered. For example, outcome engine 160 queries state data store 172 for state information of, for example, the driving simulator 110 of interest. Method 400 may proceed to step 455.

At a step 455, a plan for implementing the outcome request is created. For example, outcome engine 160 creates a plan for implementing the outcome request. More specifically, outcome engine 160 finds all the paths and then selects the shortest plan, meaning the plan that takes the least amount of time and/or least number of steps.

At a step 460, action is taken to complete the first step of the path or plan for implementing the outcome request. For example, outcome engine 160 completes the first step of the plan for implementing the outcome request. Method 400 may return to step 435.

Referring still to method 400 shown in FIG. 13, the loop through steps 435, 450, 455, and 460 may repeat until a path or plan for implementing the outcome request is achieved in a rapid and highly automated fashion. A process that is highly beneficial compared with currently available solutions that provide little automation requiring sim center operators to track the state of all things and click a button for every action.

For example, in a first loop, the first step of the plan (step 460) may be executed. Then, if the outcome is still not achieved, a next loop occurs, but now from a new plan generated from scratch (step 455) from a different starting point having executed the first step of the previous plan. In the next loop, the first step of the current plan (step 460) may be executed. Then, again if the outcome is still not achieved, a next loop occurs, but now from a new plan generated from scratch (step 455) from a different starting point having executed the first step of the previous plan. Then, continuing until the loop until the outcome is achieved. An advantage of this process is that it may be highly adaptive. Because this process can make a new plan even when conditions have changed.

By way of example, a common usage of the looping steps 435, 450, 455, and 460 for implementing the outcome request in a rapid and highly automated fashion is that of “starting a new session.” For example, when starting a new session, a driving simulator 110 is powered up, but the simulation software 112 is not running. Then, the process to get someone driving may involve a number of steps. Here, outcome engine 160 creates a plan which may include the following steps (simplified for the example):
1. launch simulation software,
2. connect to dedicated server “intro,’
3. choose the GT4 car, #18,
4. proceed to garage,
5. set options (assists, button mapping, etc.), and
6. put car on track

Then, outcome engine 160 executes the first step only—launch simulation software. Once the simulation software 112 was running it would create a new plan of:
1. connect to dedicated server “intro,”
2. choose the GT4 car, #18,
3. proceed to garage,
4. set options (assists, button mapping, etc.), and
5. put car on track

Then, simulation software 112 connects to the dedicated server 158 and outcome engine 160 creates a new plan:
1. choose the GT4 car, #18,
2. proceed to garage,
3. set options (assists, button mapping, etc.), and
4. put car on track

And so on, until the outcome is achieved. Again, if anything changes in the process of implementation, the nature of the outcome engine 160 allows it to compensate and continue pursuing the outcome.

Referring now to FIG. 14 is a flow diagram of an example of a method 500 of validating an outcome request of driving simulation system 100, in accordance with an embodiment of the invention. The steps of method 500 are used to perform decision step 315 of method 300 shown in FIG. 12. Accordingly, step 310 of method 300 is shown feeding a first step of method 500. Further, a YES output step and a NO output step of method 500 are shown feeding back into method 300 of FIG. 12. Method 500 may include, but is not limited to, the following steps.

At a decision step 510, it is determined whether the requested state change is impactful to the driver. For example, an outcome request is received from step 310 of method 300 of FIG. 12, then outcome engine 160 determines whether the requested state change has no impact to the driver. If the change is not impactful to the driver, then method 500 may proceed to step 515. However, if the change is impactful to the driver, then method 500 may proceed to step 520.

At a step 515, the state change is marked as validated and returned. For example, outcome engine 160 marks the requested state change as validated. Then, method 500 returns to step 320 of method 300 of FIG. 12.

At a step 520, a state graph is built. For example, outcome engine 160 builds a mathematical state graph (see Table 1 and Table 2). Method 500 may proceed to step 525.

At a step 525, it is determined whether there is a valid plan. For example, outcome engine 160 determines whether there is a valid plan. If there is a valid plan, then method 500 may proceed to step 530. However, if there is not a valid plan, then method 500 may proceed to step 540.

At a step 530, an estimated time to implement the plan is determined. For example, outcome engine 160 determines the estimated time to implement the plan (see Table 2). Method 500 may proceed to step 535.

At a step 535, the expected user impact is determined. For example, outcome engine 160 determines the expected user impact. Method 500 may return to step 515.

At a step 540, the state change is marked as invalid and returned. For example, outcome engine 160 marks the state change as invalid. Then, method 500 returns to step 325 of method 300 of FIG. 12.

Referring now to FIG. 15 through FIG. 27 is schematic views of an example of operations UI 162 of driving simulation system 100, in accordance with an embodiment of the invention. Outcome engine 160 of driving simulation system 100 may be used to monitor the state of each of the driving simulators 110, drivers 132, and events at sim center 190. Accordingly, operations UI 162 of driving simulation system 100 may be a declarative interface to a graph-based state mapping feature of outcome engine 160.

The graph-based state mapping feature of outcome engine 160 may be used to achieve the outcome specified by the sim center operator 192 or other system component. Further, outcomes can be “chained” into a fully automated event where they are linked by triggers. For example, the first outcome may be that the driving simulator 110 is on track in a specific car/track in a practice session. The second outcome may be that the driving simulator 110 is on track in that same car/track in a race, and the trigger is that 15 minutes of practice has elapsed.

FIG. 15 shows an example of operations UI 162 that may include a state manager portion 610 including an arrangement to car icons 612, a dedicated servers menu 614, a track window 616, a driver window 618, a sessions window 620, a state key 622, and multiple control buttons 624.

In this example, state manager portion 610 may include an arrangement of twelve car icons 612, indicated by “pod1” through “pod12.” Twelve car icons 612 is just one example. The number of car icons 612 shown in operations UI 162 may correspond to the actual number of driving simulators 110 present in any given sim center 190. Each of the car icons 612 represents one driving simulator 110. Accordingly, this example of operations UI 162 shows that the sim center 190 may include twelve driving simulators 110. The car image within each of the car icons 612 may be a default image until a race car is selected. For example, all of the car icons 612 show the default image except for “pod9.” The “pod9” car icon 612 shows a Formula One race car image. The car image within each of the car icons 612 may be helpful to sim center operators 192. For example, the car images help to quickly indicate to the sim center operator 192 what model/class car and what paint the driver has. This can be useful to know which driver is which on track and to make sure that different drivers have different paint.

Dedicated servers menu 614 shows a list of race tracks and/or events that may be supported at the particular sim center 190. Each race track or event in the list is supported by its own instance of a dedicated server 158 at session server 150. For example, if dedicated servers menu 614 shows fifteen items, then session server 150 may include dedicated servers 158-1 through 158-15. One for each item listed.

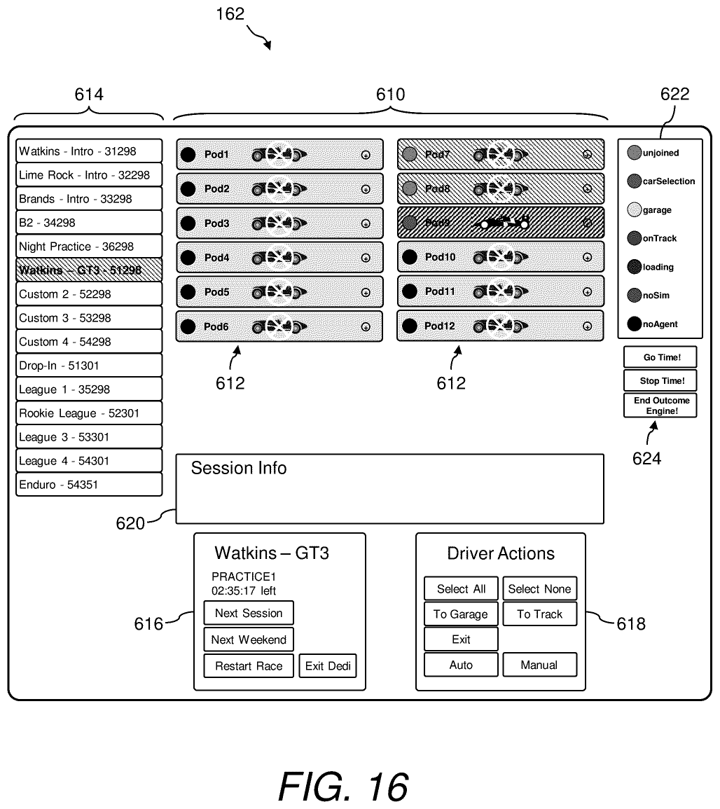

Each race track or event listed in dedicated servers menu 614 is selectable. For example, FIG. 16 shows that when “Watkins—GT3” is selected, information about “Watkins—GT3” is displayed in track window 616. Further, FIG. 15 shows that when “Watkins—GT3” is selected, the car icons 612 that are associated with this selection are highlighted, such as “pod7,” “pod8,” and “pod9.” Further, when a certain car icon 612 is selected, such as “pod9,” the sim center operator 192 may select certain driver action using driver window 618.

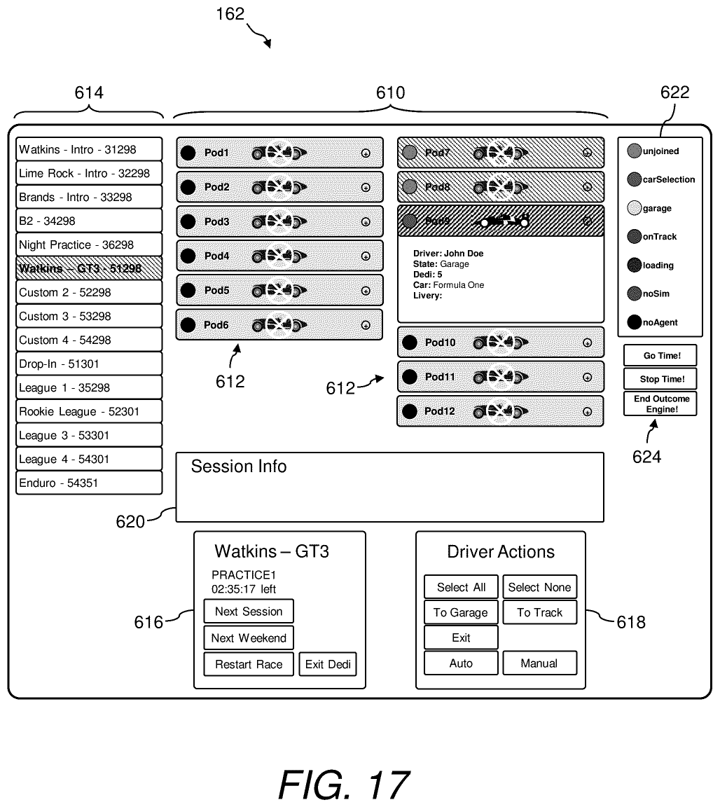

Further, FIG. 17 shows that when a certain car icon 612 is selected, such as “pod9,” a dropdown window displays more information about this driving simulator 110 and its driver 132. Further, any session information (not shown) of a particular race and/or event at the sim center 190 may be displayed within sessions window 620. For example, sessions window 620 may display a list of driving simulators 110 that are joined to the selected dedicated server 158.

Further, FIG. 15, FIG. 16, and FIG. 17 show that the state of each of the car icons 612 (i.e., each of the driving simulators 110) may be indicated according to state key 622.

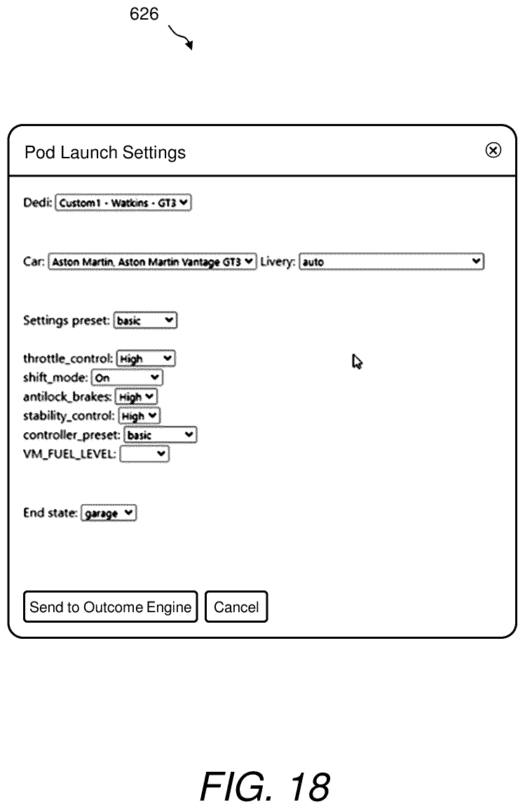

Further, the sim center operator 192 may select a certain control button 624, such as a “Go Time” button, to launch a pod launch menu 624, as shown in FIG. 18 through FIG. 26. The pod launch menu 624 provides a single menu by which the sim center operator 192 may easily set up any given driving simulator 110. By contrast, currently available solutions provide little convenience for configuring driving simulators 110, requiring sim center operators to navigate through several menus.

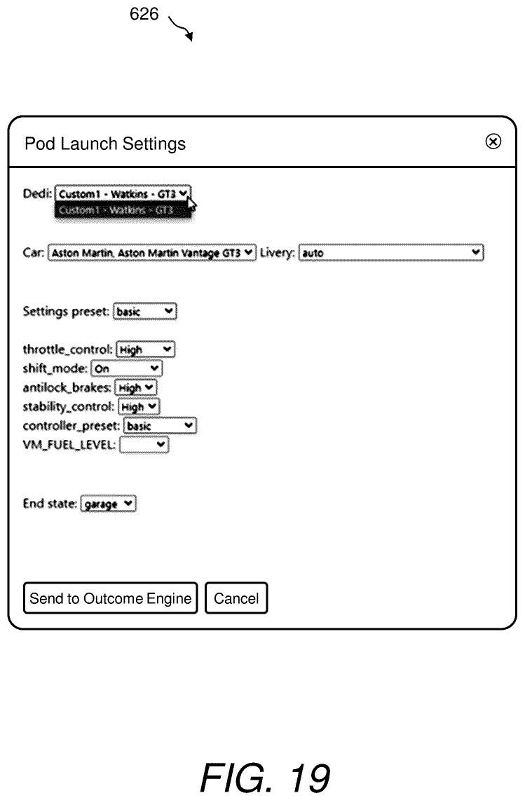

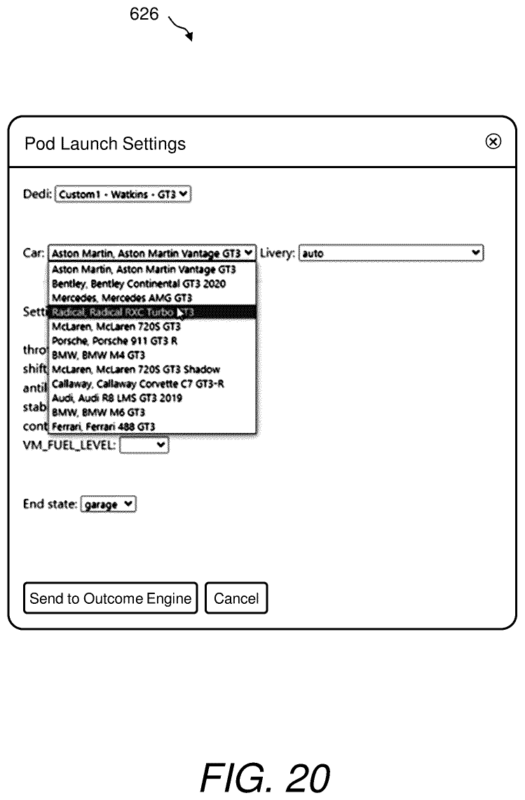

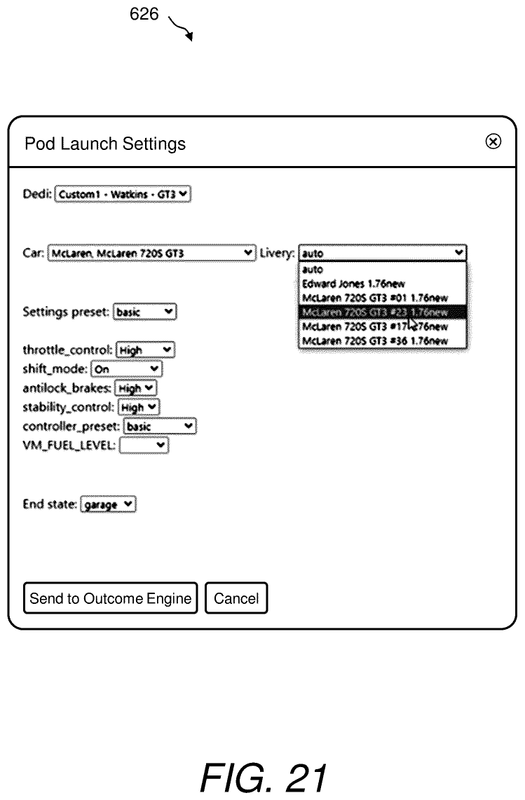

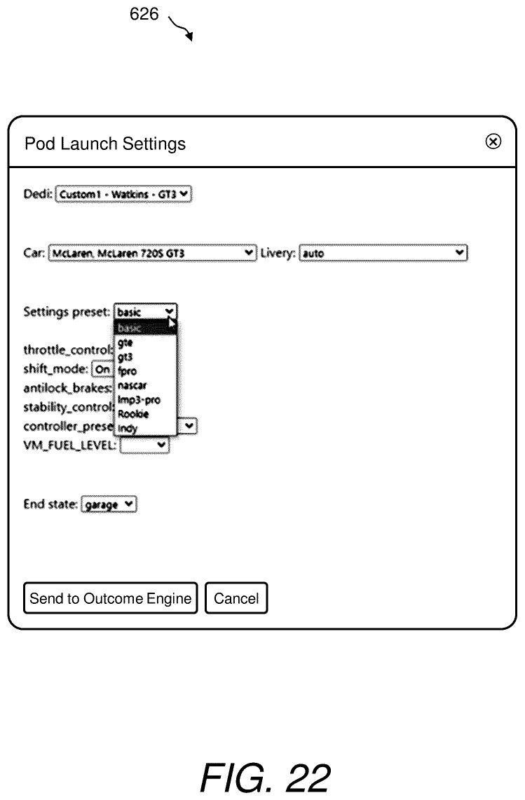

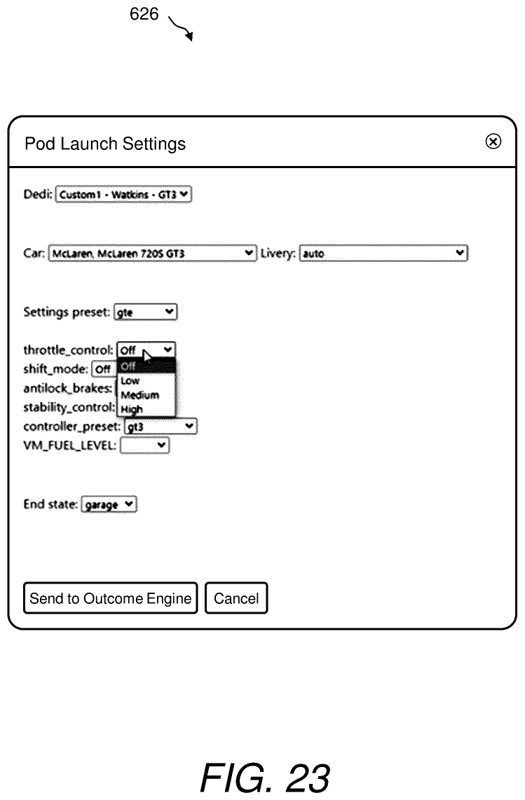

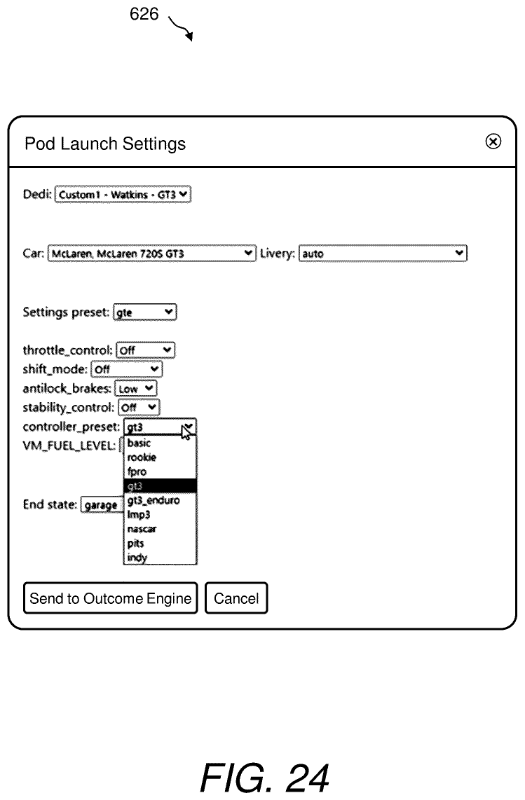

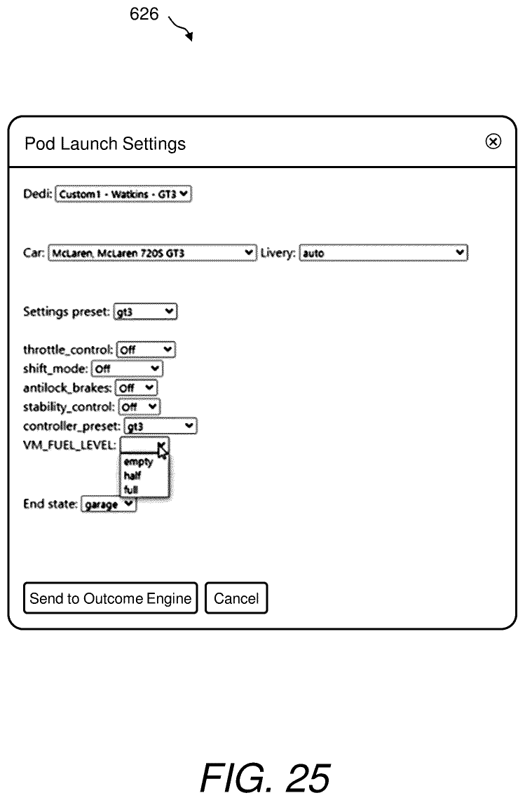

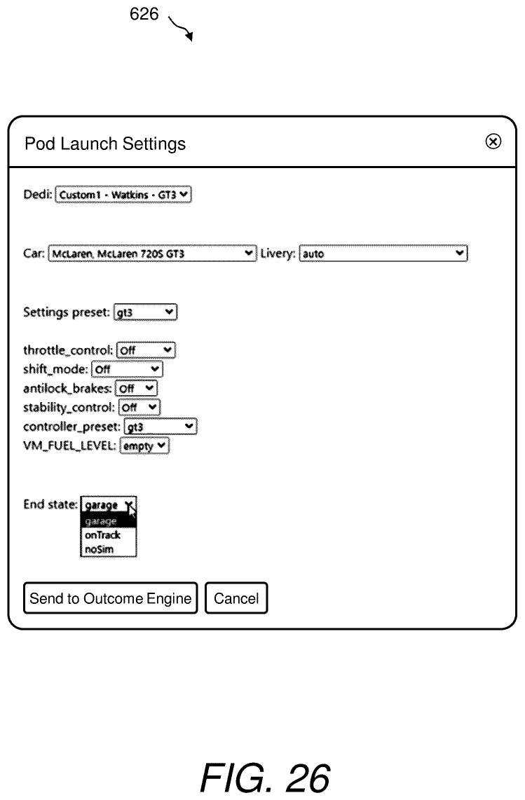

For example, FIG. 18 shows an example of pod launch menu 624. Next, FIG. 19 shows a dropdown menu for selecting a certain dedicated server 158, meaning a certain track or event. Next, FIG. 20 shows a dropdown menu for selecting a certain make of car. Next, FIG. 21 shows a dropdown menu for selecting a certain model of the selected car. Next, FIG. 22 shows a dropdown menu for selecting a certain preset setting. Next, FIG. 23 shows a dropdown menu for selecting certain assists, such as throttle control, shift mode, antilock brakes, and stability control. Next, FIG. 24 shows a dropdown menu for selecting a certain controller preset (or button mapping or button configuration). Next, FIG. 25 shows a dropdown menu for selecting a certain fuel level. Next, FIG. 26 shows a dropdown menu for selecting a certain end state, such as garage, onTrack, nosim.

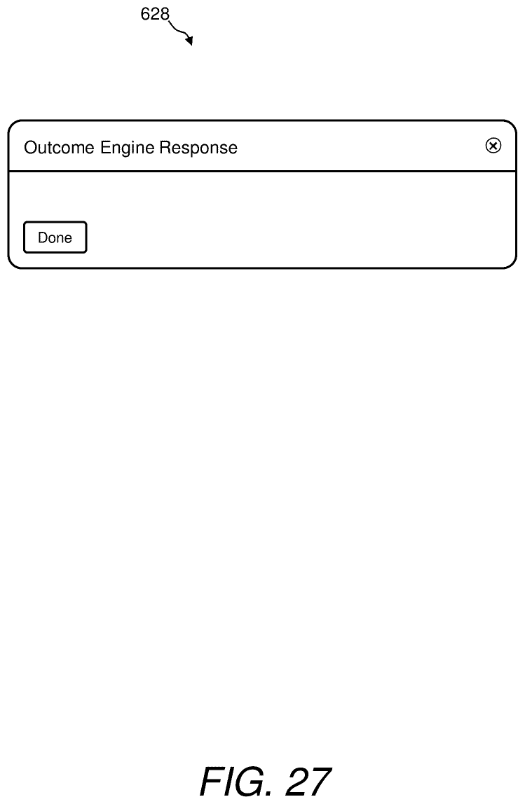

Pod launch menu 624 shown in FIG. 18 through FIG. 26 may also include certain control buttons, such as a “Send to Outcome Engine” button and a “Cancel” button. Further, FIG. 27 shows an example of an outcome engine response menu 628. That is, upon completing the selections of pod launch menu 624, the “Send to Outcome Engine” button may be used to send an outcome request to outcome engine 160 of driving simulation system 100. Then, upon receipt of the outcome request, outcome engine response menu 628 may be displayed as confirmation.

Referring now to FIG. 28 is a flow diagram of an example of a state graph 700 of driving simulation system 100, in accordance with an embodiment of the invention. In this example, state graph 700 represents the state graph used by outcome engine 160 to validate and implement requested outcomes. Specifically, state graph 700 is a simplified graph of the state graph of a driving simulator 110.

Each state has zero (0) or more settings, options, or minor states that can be manipulated while the driving simulator 110 is in that state. For example, the Traction Control setting can be changed while in an the unjoined, carSelelection, garage, or onTrack states, but Driver Name can only be changed in the unjoined state.

Thus, when creating a plan to implement a requested outcome, outcome engine 160 finds all plans that get from the current state to the desired state. Then, outcome engine 160 determines whether all required settings are accessible in that plan.

For example, the driving simulator 110 is currently onTrack in a Formula 1 car. The driver 132 requests a change to the Traction control level. The first plan evaluated shows that the driving simulator 110 is already in the requested state and that the setting is available in that state. As there is no need for a state change, the outcome is implemented and the Traction Control level is changed.

A bit later, the driver requests a different team car (livery/paint). The first plan shows again that the driving simulator 110 is in the requested end state. However, the car cannot be changed in this state, so the plan is not valid for the requested outcome. The next plan follows the path from onTrack to garage via the “leave track” action. The next path in the plan is to go to onTrack via the “go to track” action. This plan includes two states, onTrack and garage, and one of those, garage, does allow for making the requested change to the car.

Above is a simplified description as it will actually generate hundreds of plans and choose the “shortest” path that will achieve the outcome. The “shortest” path is weight based on driver impact and estimated plan duration. When a valid plan has been chosen, outcome engine 160 will return that plan to be presented for confirmation to the sim center operator 192 via operations UI 162.

In summary and referring now to FIG. 1 through FIG. 28, driving simulation system 100 and methods 200, 300, 400, 500 for managing driving simulation centers, such as sim center 190, including driving simulators 110, details of drivers 132, and broadcasts of races via spectator module 136.

In some embodiments, driving simulation system 100 and methods 200, 300, 400, 500 may include one or more driving simulators 110, session server 150 including one or more dedicated servers 158, outcome engine 160, operations UI 162, driver web portal 180, and multiple data stores, such as, but not limited to, driver data store 170, state data store 172, static data store 174, and center data store 176.

In some embodiments, driving simulation system 100 and methods 200, 300, 400, 500 provide data processing capability that may use driver web portal 180 to deliver driver data to drivers 132 after racing in an easily consumable and interesting way.

In some embodiments, driving simulation system 100 and methods 200, 300, 400, 500 may include, for example, the steps of processing an outcome request, validating an outcome request, and then implementing a requested end state or outcome.

In some embodiments, driving simulation system 100 and methods 200, 300, 400, 500 may include outcome engine 160 and operations UI 162 that may be used to automate and/or simplify the operations and/or management of sim centers 190 by sim center operators 192.

In some embodiments, driving simulation system 100 and methods 200, 300, 400, 500 may include outcome engine 160 that uses, for example, mathematical state graphs to automate the operations of sim centers 190 by optimizing the paths from one outcome state to other outcome states of driving simulators 110 and/or races.

In some embodiments, driving simulation system 100 and methods 200, 300, 400, 500 provide a system configuration wherein substantially all components thereof may be provided entirely local to the sim center 190.

In some embodiments, driving simulation system 100 and methods 200, 300, 400, 500 provide a system configuration wherein certain components thereof may be provided local to the sim center 190 and wherein other components thereof may be cloud-based.

In some embodiments, driving simulation system 100 and methods 200, 300, 400, 500 provide a platform including a suite of technologies to enable the intelligent operation of the sim center 190.

In some embodiments, driving simulation system 100 and methods 200, 300, 400, 500 provide a platform that may be used to leverage a high level of automation and thereby reduce greatly the knowledge, experience, and attention that is currently required to operate a plurality of driving simulators in a way that is flexible to each driver.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the invention.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the invention will be apparent to the skilled person without departing from the scope and spirit of the invention. Although the subject matter has been disclosed in connection with specific preferred aspects or embodiments, it should be understood that the subject matter as claimed should not be unduly limited to such specific aspects or embodiments.

The subject matter may be implemented using hardware, software, or a combination thereof and may be implemented in one or more computer systems or other processing systems. In one aspect, the subject matter is directed toward one or more computer systems capable of carrying out the functionality described herein.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A driving simulation system, comprising:
a. one or more driving simulator pods, the one or more driving simulator pods comprising: a simulated driver cockpit, comprising: simulated vehicle controls; one or more displays providing a simulated driving environment to a driver of the one or more driving simulator pods, and a driving simulator pod computer;
b. a session server;
c. an outcome engine;
d. an operations user interface;
e. a plurality of data stores;
f. one or more processors; and
g. a non-transitory computer-readable medium storing thereon instructions that, when executed by the one or more processors, cause the system to:
i. receive by the outcome engine an outcome request associated with at least one of the one or more driving simulator pods;
ii. process the outcome request to determine if the outcome request is valid or not valid; and
iii. implement the outcome request if valid.

2. The system of claim 1, wherein processing the outcome request further comprises, if the outcome request is determined to be valid, determining whether the outcome request is or is not impactful to a driver associated with the driving simulator pod associated with the outcome request, and if determined to be impactful, requiring confirmation of the outcome request prior to implementing the outcome request.

3. The system of claim 2, wherein implementing an outcome request determined to be valid and impactful comprises the outcome engine generating a state graph of all states that the driving simulator pod associated with the outcome request can be in, wherein the outcome engine queries a state data store of one of the plurality of data stores for all state information of the driving simulator pod associated with the outcome request.

4. The system of claim 3, further comprising the outcome engine generating a plan for implementing the outcome request based on the state graph and state information, wherein the outcome engine analyzes all available paths of the state graph and generates the plan taking the least amount of time and/or steps.

5. The system of claim 4, further comprising executing the generated plan, comprising:
a. completing a first step of the generated plan; and
b. determining if the outcome request is achieved.

6. The system of claim 5, further comprising recording a state change of the driving simulator pod associated with the outcome request after completing the first step of the generated plan in the state data store.

7. The system of claim 5, wherein if it is determined that the outcome request is not achieved, then the system further comprises:
a. the outcome engine generating a new state graph of the driving simulator pod associated with the outcome request;
b. generating a new plan based on the new state graph and state information;
c. completing a first step of the generated new plan;
d. determining if the outcome request is achieved; and
wherein if it is determined the outcome request is not achieved repeating 7(a)-7(d), until the outcome request is achieved.

8. The system of claim 7, further comprising recording a state change of the driving simulator pod associated with the outcome request after completing the first step of each new generated plan in the state data store.

9. The system of claim 1, wherein the outcome request is input via the operations user interface.

10. The system of claim 1, further comprising a spectator module and a spectator display, wherein the spectator module is programmed to drive the spectator display to allow a broadcast of a simulated event or race of one or more driving simulator pods of the driving simulation system, wherein the spectator display is remote of the one or more driving simulator pods.

11. The system of claim 1, further comprising a driver web portal comprising a web based portal wherein a driver of one or more of the driving simulator pods of the driving simulation system can access the driving simulation system and interact with a simulation center, their account, and/or their driver data.

12. The system of claim 1, wherein the plurality of data stores comprises one or more of a driver data store, a state data store, a static data store, and/or a simulation center data store.

13. The system of claim 1, wherein validating the outcome request comprises:
a. determining if a state change of the outcome request is impactful to the driver of the one or more driving simulator pods associated with the outcome request;
b. if it is determined that the state change of the outcome request is impactful to the driver, generating a state graph by the outcome engine;
c. based on the state graph, determining by the outcome engine if there is a valid plan to implement the state change of the outcome request; and
d. if it is determined there is a valid plan, marking the outcome request as validated and return the plan for confirmation and implementation.

14. The system of claim 15, wherein if it is determined by the outcome engine that there is not a valid plan then marking the outcome request as not validated and returning a reason for the failed validation for confirmation.

15. The system of claim 15, wherein if it is determined that the state change of the outcome request is not impactful to the driver then marking the outcome request as validated and return plan for confirmation and implementation.

16. The system of claim 15, wherein a first outcome request can be linked to a second outcome request by a trigger event, wherein upon the occurrence of the trigger event the second outcome request is implemented.

17. A method of managing a driving simulation center, the method comprising:
a. accessing a driving simulation system, the driving simulation system comprising:
i. one or more driving simulator pods, the one or more driving simulator pods comprising: a simulated driver cockpit, including simulated vehicle controls; one or more displays providing a simulated driving environment to a driver of the one or more driving simulator pods, and a driving simulator pod computer;
ii. a session server;
iii. an outcome engine;
iv. an operations user interface;
v. a plurality of data stores; and
vi. one or more processors configured for executing programmed instructions;
b. receiving by the outcome engine an outcome request associated with at least one of the one or more driving simulator pods;
c. processing the outcome request to determine if the outcome request is valid or not valid; and
d. implementing the outcome request if valid.

18. The method of claim 17, wherein processing the outcome request further comprises, if the outcome request is determined to be valid, determining whether the outcome request is or is not impactful to a driver associated with the driving simulator pod associated with the outcome request, and if determined to be impactful, requiring confirmation of the outcome request prior to implementing the outcome request.

19. The method of claim 18, wherein implementing an outcome request determined to be valid and impactful comprises the outcome engine generating a state graph of all states that the driving simulator pod associated with the outcome request can be in, wherein the outcome engine queries a state data store of one of the plurality of data stores for all state information of the driving simulator pod associated with the outcome request.

20. The method of claim 19, further comprising the outcome engine generating a plan for implementing the outcome request based on the state graph and state information, wherein the outcome engine analyzes all available paths of the state graph and generates the plan taking the least amount of time and/or steps.

21. The method of claim 20, further comprising executing the generated plan, comprising:
a. completing a first step of the generated plan; and
b. determining if the outcome request is achieved.

22. The method of claim 21, further comprising recording a state change of the driving simulator pod associated with the outcome request after completing the first step of the generated plan in the state data store.

23. The method of claim 21, wherein if it is determined that the outcome request is not achieved, then the system further comprises:
a. the outcome engine generating a new state graph of the driving simulator pod associated with the outcome request;
b. generating a new plan based on the new state graph and state information;
c. completing a first step of the generated new plan;
d. determining if the outcome request is achieved; and
wherein if it is determined the outcome request is not achieved repeating 23(a)-23(d), until the outcome request is achieved.

24. The method of claim 23, further comprising recording a state change of the driving simulator pod associated with the outcome request after completing the first step of each new generated plan in the state data store.

25. The method of claim 17, wherein the outcome request is input via the operations user interface.

26. The method of claim 17, further comprising a spectator module and a spectator display, wherein the spectator module is programmed to drive the spectator display to allow a broadcast of a simulated event or race of one or more driving simulator pods of the driving simulation system, wherein the spectator display is remote of the one or more driving simulator pods.

27. The method of claim 17, further comprising a driver web portal comprising a web based portal wherein a driver of one or more of the driving simulator pods of the driving simulation system can access the driving simulation system and interact with a simulation center, their account, and/or their driver data.

28. The method of claim 17, wherein the plurality of data stores comprises one or more of a driver data store, a state data store, a static data store, and/or a simulation center data store.

29. The method of claim 17, wherein validating the outcome request comprises:
a. determining if a state change of the outcome request is impactful to the driver of the one or more driving simulator pods associated with the outcome request;
b. if it is determined that the state change of the outcome request is impactful to the driver, generating a state graph by the outcome engine;
c. based on the state graph, determining by the outcome engine if there is a valid plan to implement the state change of the outcome request; and
d. if it is determined there is a valid plan, marking the outcome request as validated and return the plan for confirmation and implementation.

30. The method of claim 29, wherein if it is determined by the outcome engine that there is not a valid plan then marking the outcome request as not validated and returning a reason for the failed validation for confirmation.

31. The method of claim 29, wherein if it is determined that the state change of the outcome request is not impactful to the driver then marking the outcome request as validated and return plan for confirmation and implementation.

32. The method of claim 17, wherein a first outcome request can be linked to a second outcome request by a trigger event, wherein upon the occurrence of the trigger event the second outcome request is implemented.
